(19) United States
(12) Patent Application Publication
(10) Pub. No.: US 2014/0265577 A1
(43) Pub. Date: Sep. 18, 2014

(54) ELECTRICAL POWER SWITCHING TECHNIQUES

(71) Applicant: Christopher V. Beckman, San Diego, CA (US)

(72) Inventor: Christopher V. Beckman, San Diego, CA (US)

(21) Appl. No.: 14/033,456

(22) Filed: Sep. 21, 2013

Related U.S. Application Data
(60) Provisional application No. 61/852,154, filed on Mar. 15, 2013.
(60) Provisional application No. 61/861,401, filed on Aug. 1, 2013.

(51) Int. Cl. H02J 3/00

(52) U.S. Cl. CPC H02J 3/00
USPC 307/39

(57) ABSTRACT

New techniques improving the efficiency of electrical power distribution are provided. In some aspects of the invention, a control unit, with additional switching hardware (in addition to any main circuit switch) switches power from an electrical outlet. In some embodiments, specialized sensory hardware may be included, and may comprise appliance control actuation devices and touch or power control actuation sensors installed on or about a main power control, and may further comprise a near field or other wireless communication tag(s). In other embodiments, such sensory hardware may comprise a power status light or other indicator sensor, proxy control and appliance control actuator.

Among other aspects, some embodiments also provide for control system programmability, to learn actuation and indicator conditions associated with an appliance being turned off or on, or otherwise actuated, and the control unit may control power distribution based on such variable programming.

### CROSS-REFERENCE TO RELATED APPLICATION

This application claims the benefit of U.S. Provisional Application No. 61/852,154, filed Mar. 15, 2013, and U.S. Provisional Application No. 61/861,401, filed Aug. 1, 2013, the entire contents of both of which are hereby incorporated by reference herein.

### FIELD OF THE INVENTION

The present invention relates to techniques using devices with additional power switches to eliminate electronic leakage when powering electrical circuits, appliances and outlets. The present invention also relates to peripheral devices that enhance and extend the performance of such switches, appliances, and hardware.

### BACKGROUND OF THE INVENTION

The waste of electrical and other power resources leads to substantial economic and other losses worldwide. Among other issues, appliances and circuits operate with varying efficiency, and may continue to expend power when “switched off,” meaning that they are placed in a relatively inactive or unused state. The power consumed by appliances that are “switched off” is known as “electronic leakage,” and is a matter of public concern. See, e.g., U.S. Pat. No. 8,410,639.

Many appliances include a “main power” switch or other hardware allowing a user to “switch off” an appliance. Such hardware occurs in a wide variety of forms, such as buttons, switches, transistors, radio frequency remote control receivers and computer processors. In addition, some such appliances include status-indicator lights and displays, which, in some cases, relate to the activity state of an appliance. In some instances, such indicators “switch on,” meaning that they are placed in a relatively active or used state, when an appliance itself is switched on. Conversely, in other instances, such indicators switch on when an appliance is itself switched off—as is the case with a light indicating that an appliance is in a Standby mode. Rather than switching on and off, some indicators may change color, or otherwise change their appearance or physical condition to indicate whether an appliance has been switched on or switched off.

In modern appliances, one appliance may at least partially control another appliance, and issue commands that affect its status. In some instances, such commands may be issued wirelessly. For example, a personal computer may communicate over a local area network with a peripheral device, such as a printer, which may, for example, activate the printer (switching it on) to carry out a printing job, or switch off when the job is completed (if no further print commands are received before switching off). Some network-based applications under development flexibly link appliances and devices, such that carrying out an act with one device or appliance affects the operation of another device or appliance. See, e.g., Belkin Wemo IFTTT informational web page, available at http://www.belkin.com/us/wemo/ifttt, accessed Sep. 8, 2013.

Near Field Communication devices have also been under development for many years. Some Near Field Communication devices, called “tags,” communicate with the aid of an external, inductive power source and, therefore, need not incorporate an on-board battery or wiring to an external power source.

It should be understood that the disclosures in this application related to the background of the invention, in, but not limited to this section titled “Background of the Invention,” do not necessarily set forth prior art or other known aspects exclusively, and may instead include art that was invented concurrently or after the present invention and conception, and details of the inventor's own discoveries and work and work results.

### SUMMARY OF THE INVENTION

New techniques improving the efficiency of electrical power distribution are provided. In some aspects of the invention, a control unit distributes, halts or limits power from an electrical outlet based on readings from specialized sensory hardware, which may be reversibly installed on the housing of an appliance. In some embodiments, specialized sensory hardware may comprise appliance control actuation devices and touch or power control actuation sensors installed on or about a main power control, and may further comprise a near field or other wireless communication tag(s). In other embodiments, such sensory hardware may comprise a power status light or other indicator sensor, proxy control and/or appliance control actuator.

Among other aspects, some embodiments also provide for control system programmability, to learn actuation and indicator conditions associated with an appliance being turned off or on, or otherwise being actuated, and the control unit may control power distribution based on such variable programming. In still other aspects, a control system may implement reduced levels of voltage, current and other electrical characteristics, assess the impact of such reduced levels on the performance of the appliance, determine optimized levels of such electrical characteristics for provision to the appliance, and provide such optimized levels.

### CANONS OF CONSTRUCTION AND DEFINITIONS

Where any term is set forth in a sentence, clause or statement (“statement”), each possible meaning, significance and/or sense of any term used in this application should be read as if separately, conjunctively and/or alternatively set forth in additional statements, as necessary to exhaust the possible meanings of each such term and each such statement.

It should also be understood that, for convenience and readability, this application may set forth particular pronouns, articles and other linguistic qualifiers of various specific gender and number, but, where this occurs, all other logically possible gender and number alternatives should also be read in as both conjunctive and alternative statements, as if equally, separately set forth therein.

“Electrical characteristic,” in addition to its ordinary meaning and special meaning in the art to which it pertains, means the voltage, current, resistance, power output, or other aspect of or factor of (or affecting or potentially affecting) an electrical circuit, electrical device or other electrical component, appliance or method, or a capability of such an electrical circuit, device or other electrical component or method.

“Switched on,” in addition to its ordinary meaning and special meaning in the art to which it pertains, when used to describe the state of an electrical circuit, device, component or appliance, means that the circuit, device, component or appliance has entered a relatively active or currently used state, leading to the consumption or potential consumption of more (or consumption at a greater rate or greater average rate of) power, in comparison to other states.

“Switched off,” in addition to its ordinary meaning and special meaning in the art to which it pertains, when used to describe the state of an electrical circuit, device, component or appliance, means that the circuit, device, component or appliance has entered a relatively inactive or currently unused state, leading to the consumption or potential consumption of less (or consumption at a lower rate or lower average rate of) power, in comparison to other states.

“Actuated conformation,” in addition to its ordinary meaning and special meaning in the art to which it pertains, when used to describe a user interface control, such as, but not limited to buttons, switches, knobs, levers, dials, sliders and other, digitally-actuated control aspects, means the physical state of the user interface control after being actuated.

“Conformation pattern during actuation,” in addition to its ordinary meaning and special meaning in the art to which it pertains, when used to describe a user interface control, such as, but not limited to buttons, switches, knobs, levers, dials, sliders and other digitally-actuated control aspects, means a change in physical state of the user interface control during actuation.

### BRIEF DESCRIPTION OF THE DRAWINGS

FIG. 1 is a perspective view of an exemplary electronic appliance, which will serve as a platform for discussing certain aspects of the present invention.

FIG. 2 is a front view of an exemplary electrical outlet, into which an appliance, such as the appliance discussed with reference to FIG. 1, may be plugged and, as a result, receive power.

FIG. 3 is a view in the same perspective as FIG. 1, depicting the same exemplary electronic appliance, along with certain sensing devices used in aspects of the present invention.

FIG. 4 is a front view of an exemplary control unit, shown mounted on, and able to receive and control electrical power from, a socket of a duplex electrical outlet.

FIG. 5 is bottom view of the control unit embodiment discussed above, in reference to FIG. 4, revealing additional mounting and electrical conduction hardware.

FIG. 6 is a view in the same perspective as FIGS. 1 and 3, depicting the same exemplary electronic appliance, along with certain alternative sensing devices used in additional embodiments of the present invention.

FIG. 7 is a perspective drawing depicting an exemplary adhesive light-sensing device, such as the light-sensing device discussed above, in reference to FIG. 3, but at greater magnification and in greater detail than that depicted in FIG. 3.

FIG. 8 is another magnified perspective drawing depicting a different exemplary embodiment of an adhesive light-sensing device, such as the light-sensing device discussed above, in reference to FIG. 3.

FIG. 9 is another magnified perspective drawing depicting a different exemplary embodiment of an adhesive indicator- and actuation-sensing device, with some similar, and some new, functions in comparison to light-sensing devices discussed above.

FIG. 10 is a magnified perspective drawing depicting an exemplary embodiment of an adhesive button device comprising a new form of communications tag, in accordance with aspects of the present invention.

FIG. 11 is a top-view drawing depicting elements of the new form of communications tag discussed with reference to FIG. 10 in greater detail, and separated from other aspects of the invention, for clarity.

FIG. 12 is a magnified top view depicting aspects of another exemplary adhesive button device comprising another new type of communications apparatus, in accordance with aspects of the present invention.

FIG. 13 is same magnified top view of the button device discussed in reference to FIG. 12, further depicting a push-button piece for actuating the device.

FIG. 14 is a top view of aspects of another exemplary adhesive button device, which is also discussed with reference to additional, more complete, figures, following FIG. 14.

FIG. 15 is a side view depicting a damping piece for muting dominant or other selected tones from a resonant strip within the adhesive button device discussed with reference to FIG. 14 and with reference to additional figures, which follow.

FIG. 16 is a perspective view of additional aspects of the button device discussed with reference to FIGS. 14 and 15, and additional figures, which follow.

FIG. 17 is in the same perspective as FIG. 16 and depicts the same aspects of a button device discussed with reference to FIGS. 14-16, with the additional elements of damping piece also installed.

FIG. 18 depicts the same button device depicted in FIGS. 14-17, in a more complete state, including a flexible, compressible top surface.

FIG. 19 is a perspective view of an additional form of adhesive button device, which may operate by touch-capacitance or touch-resistance actuation.

FIG. 20 is perspective view depicting a set of adhesive button devices, which may each be similar in nature to the adhesive button device discussed with reference to FIG. 19, above.

FIG. 21 is a process flow diagram depicting exemplary steps that may be executed by a control system implementing exemplary programming, methodology and other aspects of the present invention.

FIG. 22 is another process flow diagram depicting additional exemplary steps that may be executed by a control system implementing exemplary programming, methodology and other aspects of the present invention.

FIG. 23 is a schematic block diagram of some elements of an exemplary control system that may be used in accordance with aspects of the present invention.

FIG. 24 is a front view depicting an appliance-sensing, and -actuating and control unit peripheral device, next to an appliance, on which the device may be installed by a user.

FIG. 25 is a sectional side view depicting additional exemplary aspects of the same peripheral device discussed with reference to FIG. 24, above.

FIG. 26 is a perspective view depicting certain mechanical aspects of a toggle-style electrical switch, without a cover plate, which will serve as a platform for discussing further power control actuation techniques in accordance with aspects of the present invention.

FIG. 27 is a view from the same perspective as FIG. 26, above, of the same electrical switch and an additional switch actuation device installed onto it, in accordance with aspects of the present invention.

FIG. 28 is another process flow diagram depicting additional exemplary steps that may be executed by a control system implementing aspects of the present invention related to devices capable of actuating controls of an appliance.

FIG. 29 is a depiction of an exemplary external GUI, which may be used with a control unit and/or control system, as set forth in various other embodiments of the invention covered in this application.

FIG. 30 is another depiction of another exemplary external GUI which may be used with such a control system, implementing energy usage display, trading and control techniques.

### DETAILED DESCRIPTION OF THE INVENTION

FIG. 1 is a perspective view of an exemplary electronic appliance 101, which will serve as a platform for discussing certain aspects of the present invention. The exemplary electronic appliance 101 is an audio-video receiver, comprising, inter alia, a main display 103, a main power button 105, and a status-indicating light 107, proximate to main power button 105. Appliance 101 also may comprise an antenna (not pictured) for transmitting and receiving wireless communications, and may comprise additional user interface controls on a remote control device (not pictured) or beneath a releasable door 109. Main display 103 may take on a wide variety of forms and perform multiple presentation tasks relevant to the operation of appliance 101 including, but not limited to, displaying audio volume levels, output levels, mode settings, media, performance-relevant information, wireless network statuses and network-conveyed information, and the status of other home theater devices connected with appliance 101. As also discussed elsewhere in this application, user interface controls and status-indicators, such as 105 and 107, are present in some appliances and may take on a wide variety of alternative forms, any of which may be addressed by, and fall within the scope of, the invention. The particular forms set forth herein are exemplary.

Main power button 105 is a user-interface control, enabling a user to actuate it and cause the appliance 101 to be switched on or switched off. In the example pictured, main power button 105 is spring-loaded and digitally depressible by a user, and its degree of depressibility and other movements depend on its present status (i.e., whether it is presently switched on or switched off). When switched on, it is held in a more depressed resting position, albeit not fully depressed within its range of motion, due to a catch holding it in that resting position when so switched on. From that position, if then sufficiently pressed, button 105 will depress further and be released from that catch and the button's spring loading will cause it to become more extended from the main housing 100 of the appliance when switched off, than it had been when switched on. The net effect of its actuation method and characteristics is that button 105 follows a conformation pattern during actuation. When addressed by techniques of the invention, set forth below, such conformation patterns during actuation may be monitored, recorded and aid in executing further aspects of the present invention. However, the conformation pattern during actuation discussed here is illustrative, and not exhaustive of the many conformation patterns experienced and exhibited by user interface controls—each of which may be so monitored and recorded. For example, in some instances, a button may depress to the same degree when being switched on and when being switched off. In others, a button may depress to a negligible degree, and not substantially move relative to a housing. In such instances, the actuation may still be monitored, by techniques that will be discussed in greater detail, below.

Similarly, status-indicating light 107 is but one of countless possibilities and, in some embodiments, button 105 may comprise a status-indicating light or other indicating aspect (such as a variable indicator-exposing window, or the different degrees of depression when switched on and switched off, such as those discussed above), or, conversely, an indicator may comprise a user interface control. However, to aid in discussion, such possibilities include the following. In some embodiments, status-indicating light 107 may be: (A) off, not emitting light, when the main power of the appliance is switched off (a “on-indicating light”); (B) on, emitting light, when the main power of the appliance is switched off (same); (C) on, emitting light, when the main power of the appliance is switched off (a.k.a. a “standby-indicating light”); (D) off, not emitting light, when the main power of the appliance is switched on (same); (E) more or less greatly lit or emissive (or dimmed) when the appliance is switched off or switched on; (F) altered in its color or by another effect when the appliance is switched off or switched on; (G) patterned in its emission, or otherwise varied in its indications over time to indicate whether an appliance is switched on or switched off; and/or (H) any of the above indicating actions or conditions to indicate power consumption states and appliance activity other than being switched on or switched off. Each such status-indicating performance (or absence of performance), and many others, may be monitored, recorded and aid in executing further aspects of the present invention, as will be discussed further below.

FIG. 2 is a front view of an exemplary duplex electrical outlet 201, into which an appliance, such as the appliance discussed with reference to FIG. 1, may be plugged and, as a result, receive power. Outlet 201 contains two sockets 203, each of which may accept a plug from, and deliver electricity to, an appliance. Each of sockets 203 is held and protected by a housing plate 205, with complementary ports 207. Sockets 203 each contain female plug-receiving slots, such as those examples shown as 209, which further comprise electrical contacts for interfacing with male prongs of a power plug (not pictured).

As will be explained in greater detail, below, aspects of the invention interface with both an electrical outlet, such as 201, and an appliance, to carry out electrical power control techniques.

FIG. 3 is a view in the same perspective and depicting the same exemplary electronic appliance (now 301) as in FIG. 1, along with certain sensing devices used in aspects of the present invention. An adhesive light-sensing device 304 is now pictured, reversibly joined or adhered to the main housing (now 300) of the appliance, and mounted such that its generally circular sensory section 308 is centered on the status-indicating light (now 307). Because, in some embodiments, device 304 comprises a central window 311, a user may continue to view status indications from light 307, even with device 304 mounted over it, as pictured. Among other things, device 304 comprises light sensors (not pictured in FIG. 3) for ascertaining the status indications of light 307. Examples of light-sensing device embodiments, and comprised sensors and sensor arrays, are provided below, in reference to FIGS. 7-9. In some embodiments, device 304 may ascertain whether light 307 is emitting light, merely reflecting ambient light, or emitting light of particular power levels, colors, among other light characteristics.

Device 304 may be powered and controlled by a control unit, such as the control unit discussed with reference to FIG. 4, below. In some embodiments, power, and control command signals, may be provided by a flexible, conductive and insulated wire 313, which preferably matches the color, light-absorbency, finish and other aesthetic characteristics of main housing 300, or that area of housing 300 along which it is mounted. In some embodiments, insulated wire 313 may comprise adhering device(s), such as, but not limited to, sticky pads, strips (and, preferably, reversibly sticky pads or strips, or an otherwise reversibly joined or adhered device, meaning that the device (and attached item, in this instance, wire 313) may be removed without leaving substantially user-noticeable or otherwise use-affecting residual damage or substances on housing 300), or electrostatic or magnetic force-exerting pieces. In some embodiments, wire 313 itself may be elastomeric, and able to be stretched about, and, as a result, grip housing 300. A conductor within wire 313 (not pictured) may be folded, coiled, or itself flexible, while it (or another associated member) is also flexible and resilient enough to provide spring force, and impart an elastic property to wire 313. Such conductors and members may be encapsulated in a tube or other inner housing, which itself may be flexible, such that the appearance of wire 313 remains more uniform along its length in any degree that wire 313 is stretched, than it would be without such a tube (e.g., less bumpy on its surface which might occur due to an inner coiled member stretching). In other embodiments, wire 313 may be mounted about a less visible surface, such as the bottom of appliance 301, and the particular location shown, although a useful embodiment, is exemplary only, and not exhaustive of the many possible mounting positions. Some of the aspects discussed immediately above serve to decrease the visible profile of wire 313, and minimize the visible changes to the appliance, and may generally improve the adherence and viewing characteristics of wire 313, among other surprising benefits.

As the reader may notice at this stage, where possible, the same or similar aspects between figures are at times given the same latter two digits, to aid in navigating this application (e.g., the appliance housing 300 of FIG. 3 is the same appliance housing 100 of FIG. 1).

FIG. 4 is a front view of an exemplary control unit 401, shown mounted on, and able to receive and control, among other things, electrical power from, a socket of an electrical outlet, such as duplex outlet 402. An exemplary manner in which control unit 401 may be mounted on an electrical outlet socket will be discussed in greater detail below, in reference to FIG. 5, which depicts specialized conductive and mounting hardware of control unit 401, among other things, but, in some embodiments, control unit 401 comprises a plug with prongs that may be inserted into an outlet socket. Such prongs may be attached to switchable conductors, controlled by a hardware and software control system (not pictured in FIG. 4). Exemplary hardware and software control systems that may be used to control such switchable conductors, and carry out other control unit functions, discussed herein, are provided, among other sections of this application, with reference to FIG. 23, below. Control unit 401 further comprises an auxiliary power outlet socket 411, on the front face of the housing 400 of control unit 401. In the embodiment pictured, socket 411 is recessed into the housing 400, reducing the space occupied by a power plug, when installed into socket 411. A ramped bevel 412 transitioning between housing 400 and the socket 411, recessed within it, may ease the act of inserting a power plug into socket 411.

As will be discussed in greater detail below, control unit 401 may comprise user interface features, such as exemplary control buttons 414, 415 and 417, and display 419. It should be understood that a wide variety of different user interface hardware may also, or alternatively, be used, but the exemplary hardware pictured represents one optimization balancing usability factors, such as carrying out certain aspects of the invention with a small physical footprint and providing easy access for digital actuation of the controls. For instance, in the example provided, the housing 400 does not extend beyond the width of the outlet 402. However, an electrically conducting wire 413 extends from the remainder of control unit 401, and may be attached, and able to provide power and communications to a power status indication detection device (such as, but not limited to, device 304, discussed above). In other words, wire 413 may be the same wire pictured as 313 previously, and may be only partially pictured in each of the two figures (FIG. 3 and FIG. 4). To protect wire 413 from potentially damaging bending movements, and to guide it away from housing 401 and other appliance plugs engaged with another socket of the outlet, an elastomeric guidance section 421 is provided, with elastomeric protective blocks 423 and an elastomeric (e.g., rubber) main body 425. Based on sensed statuses and activity from sensors, or other input and output through wire 413, the hardware and software control system of control unit 401 may execute functions to control the provision of power from the outlet socket in which it is installed, through its output socket 411, and to an appliance plugged into output socket 411, as will be discussed in greater detail immediately below and with respect to additional figures.

Generally, control unit 401 may provide, or halt the provision of, electrical power, and, in some embodiments, other electrical characteristics, when certain appliance power, power mode or hardware conditions or statuses are indicated (e.g., as sensed by sensors or other condition-ascertaining hardware, such as power status indication detection device 304). While the nature of particular power delivery, condition sensing and ascertainment are discussed in greater detail, below, they comprise processes whereby: (1) near-field communication hardware detects and communicates to the control unit if an appliance power or standby switch is actuated to switch off or switch on an appliance; (2) sensors detect and communicate to the control unit if an appliance power or standby switch is actuated to switch off or switch on an appliance; and/or (3) sensors detect and communicate to the control unit if an appliance power or standby indicator indicates whether an appliance has been switched off or switched on. For example, if a user has installed a power status indication detection device, such as 304, over a power status indicating light, as pictured in FIG. 1, which illuminates when the appliance is switched on, the control system of the control unit 401 may be programmed to cease (or, in some embodiments, substantially reduce, such that some powered operations may still be carried out by the appliance) delivering power from the outlet 402 to the appliance, via socket 411, when device 304 senses that the indicating light has turned off. In some embodiments, control unit 401 may delay so cutting off power from outlet 402 or otherwise await the performance of a shutdown routine carried out by the appliance and/or control unit. In some embodiments, control unit 401 may be programmed by a user and/or system to carry out such routines or provide particular delay times. Examples of such routines include providing a graduated reduction or other progression of power levels to the appliance.

After cutting off power from outlet 402 to an appliance, unless a user or system actuates a control restoring that power, such as button 414, the appliance thus remains consuming no power from the outlet (or, in some embodiments, consumes a substantially reduced level of power, or rate of electrical characteristics). In some embodiments, such controls restoring power may comprise tags placed on or near power and other actuation controls on the appliance, or hardware for receiving radio frequency (“RF”) or other wireless communications, as will be discussed in greater detail below. In some embodiments, a user and/or control system may be programmed to associate appliance control actuation states, and indicator statuses, with a state or condition of the appliance as switched on or switched off. For example, by depressing button 415, a user may indicate to the control system that the appliance is presently switched on, and the control system may save recordings of signals from appliance control and/or indicator-sensing and condition-ascertaining hardware, and associate those recordings and represented signals with the appliance being switched on. As a result, when substantially the same appliance control actuation and indications are sensed, producing substantially the same signals, the control system may maintain or restore full operational power from the outlet, appropriate for operation of the appliance. Similarly, a user or system may use button 417 to program the control unit with recordings of signals corresponding with power control actuation switching off the appliance, and take steps to eliminate providing power to the appliance from the outlet when substantially the same recordings are sensed. In this way, the control unit may be programmed to work with virtually any form of appliance power control or status indicator, of a wide variety of appliances.

In addition to sensing appliance indicators and power-related controls via sensors or other condition-ascertaining hardware, control unit 401 may also employ an RF (radio frequency or other wireless communications) antenna, or other wireless communications hardware. In some embodiments, such wireless communications hardware may ascertain or intercept, and be programmable to ascertain or intercept, signals affecting the power status of an appliance controlled by the control unit (such as an appliance remote control or local network signal to switch off or switch on the appliance). In such embodiments, the control unit (or other control units and control systems discussed in this application) may take the same actions set forth in this application that take place when manual actuation or indications related to the power status of an appliance are sensed—as will be discussed in greater detail, below. In some embodiments, such antenna(s) or hardware may reside in a common housing with sensors or other condition-ascertaining hardware, such as 304, such that they are more likely to be present in a user's line-of-sight and more accessible to RF communications from a remote control. In such embodiments, control unit 401 may be programmed to associate RF frequencies, and patterns and other characteristics thereof, with main power and standby commands from such a remote control and, when detected, take action to provide, alter or eliminate power provision as discussed above from the outlet to an appliance plugged into socket 411 and control unit 401. As another alternative embodiment, or in addition, control unit 401 may comprise an RF antenna or other wireless communications hardware within its main housing 400, or elsewhere. In some embodiments, such an antenna or other wireless communications hardware comprised within control unit 401 and hardware external to the control unit, such as 304, may obviate the need for a wire (e.g. 313/413) and wired communications, because the control unit and the external hardware may communicate indication and other hardware statuses wirelessly. In such embodiments, preferably, the external hardware may be powered by an ambient power source, and/or may be inductively powered by inductive power delivery hardware, for example, from control unit 401.

Any control present on control unit 401 may comprise indicators (e.g., glowing when actuated, or otherwise subject to relevant activity, with an internal L.E.D. shining through an opaque medium comprised in the control). In addition, or alternatively, separate indicators and displays may be used to aid in programming and understanding the operations of control unit 401, external hardware and an associated appliance(s). For example, control unit 401 may comprise a separate display (such as a liquid crystal display) 419, which may communicate a wide variety of messages from a comprised control system and/or another control system. For example, display 419 may indicate when an associated appliance is switched on or switched off, and may confirm when signals are recorded for programming whether the appliance is switched on or switched off. Due to its flexibility, a display such as 419 may also display a wide variety of information potentially of interest to a user, such as the amount of power saved by operation of control unit 401 generally, or in use with a particular appliance, or at or over a particular time, and may indicate power consumption readings (with associated power consumption reading and recording hardware) to aid the user in assessing the efficiency of the appliance. In some embodiments, a user may actuate a control to adjust the sensitivity of external hardware (such as indication-sensing and actuation-ascertaining hardware) for sensing and ascertaining conditions relevant to power consumption. For example, a user may hold down button 415 for a sufficient length of time (such as 3 seconds) to indicate that he or she wishes to decrease the sensitivity of the hardware, meaning that a greater, or more substantially matching actuation or indication, or associated reading and signal, in comparison with programmed recordings, must be received by the control unit 401 before actions are taken. Similarly, a user may hold down button 417 for such a sufficient length of time to increase the sensitivity of that hardware, meaning that a lower or less substantially matching actuation or indication, or associated reading and signal, in comparison with programmed recordings, must be received by the control unit 401 before actions are taken. As pictured, the roles of such sensitivity or other input degree or type, or other reaction condition, setting controls may be provided and explained by explanatory signage 416.

In some embodiments, control unit 401 may reduce voltage or power delivery to the appliance to a minimum operational standard of the appliance, which may be variably programmed by the system and/or a user, reducing its power consumption to a lower, but still sufficient level, for example, for general or specific required operations. For example, the control system may be set with a power or voltage level by a user, learned from literature concerning the product. Alternatively, the system and/or user may “dial down” the power supplied from socket 411 (for example, using a power converter and/or transformer) until an adverse or non-operational condition is detected, and furnish a level of power, voltage or other electrical characteristics above such a “critical” level, but below other levels that might otherwise be provided (a.k.a. “superfluous” or “wasteful” levels). Examples of such adverse and non-operational conditions may include where a power-indicating light dims substantially, or the load drawn by the appliance deviates from a level or pattern associated with proper functioning of the appliance. But these particular embodiments and measures are exemplary, and not exhaustive, of the various possibilities falling within the scope of the invention. Embodiments implementing such aspects of the invention are discussed in greater detail below, for example, with reference to FIG. 28.

FIG. 5 is a bottom view of the control unit (now 501) embodiment discussed above, in reference to FIG. 4, revealing additional mounting and electrical conduction hardware. From this new perspective, from below control unit 501, some, but not all, of the aspects discussed with reference to FIG. 4 are also still visible, including, but not limited to, the control unit housing (now 500), wire (now 513), the two lowest buttons on the face of the housing (now 515 and 517) and the elastomeric guidance unit, with protective blocks and main body (now 521, 523 and 525, respectively). New attributes of some such aspects are now visible from this perspective, such as the slope of the ramped bevel, now 512, in the recession of the socket, now 511, in housing 500, easing the insertion of a power plug into socket 511, and reducing its profile when inserted.

The additional hardware aspects now visible in FIG. 5 include, but are not limited to, prong-receiving female connectors 527, within socket 511. Female connectors 527 comprise electrical contacts, such as those examples provided as 529, on their inner surfaces, for accepting the prongs of a power plug, and delivering electrical power and other electrical characteristics to such prongs. As discussed above, such contacts are able to be switched on and off, and a wide variety of electrical power and other electrical characteristics, including various settings, patterns and levels thereof, may be selected by a control system 531 and/or user of control unit 501 for delivery and application to an appliance, via contacts 529. As mentioned above, an exemplary control system is set forth below, in reference to FIG. 23, and may carry out various process steps in this regard, examples of which are also provided below, for example, in reference to FIGS. 21, 22 and 28. Control system 531 is connected to, and able to actuate hardware related to, contacts 529, and also is connected to, and able to actuate and communicate with, user interface aspects, such as buttons 515 and 517 and a display (not pictured in this figure). For example, control system 531 may comprise user and system-actuable switches, and electrical power and other characteristics conversion and conditioning hardware, to selectably terminate or alter power or other electrical characteristics and/or signals delivery from an electrical outlet (not pictured in this figure) through electrical contacts 533, of its own male prongs 535, to an appliance. In some embodiments, male prongs 535 and female connectors 527 may each be switchable (on and off) by switching hardware connected to, and governed by, control system 531. In others, either prongs 535 or connectors 527, or some of them, may be so switchable by control system 531. In yet other embodiments, power delivery and power delivery termination switching hardware, along with conversion, conditioning and filtering hardware, may be present, or comprised in hardware, intermediate to prongs 535 and connectors 527. Such intermediate hardware may comprise multiplex switching and bypass hardware. For example, if control unit 501 is presently permitting the transmission of electrical power from an outlet to an appliance, without converting or conditioning that power, it may directly connect prongs 535 and connectors 527 in some embodiments, to avoid applying internal resistance to the resulting circuit with additional hardware, by controlling switches directly connected to, or between, prongs 535 and connectors 527, or some of them. In some such embodiments, however, such direct transmission or intermediate hardware conditioning, converting or adding power and other electrical characteristics may be selectively added to the circuit, as the control system determines to then be needed, with switching hardware.

Also newly visible in FIG. 5 is a backing plate 537 comprising part of male prongs 535. Backing plate 537 may protect and house prongs 535 and specialized hardware related to them, and provides a complementarily-shaped interface for physical placement on or about the face of a power outlet and its socket (not pictured). In some embodiments, backing plate 537 comprises an elastomeric or other bumper, for preventing scratching or other damage to either the outlet or control unit 501 at that interface, and provides an insulated buffer and gap between the outlet and aspects of the control unit, such as wire 513.

As mentioned above, control unit 501 may comprise a wide variety of additional or alternative hardware not specifically pictured in FIG. 5, in various embodiments, such as, but not limited to, wireless communications hardware. These and other embodiments set forth in the present application are exemplary only, and not exhaustive of the many combinations and possibilities falling within the scope of the invention.

FIG. 6 is a view in the same perspective as FIGS. 1 and 3, depicting the same exemplary electronic appliance (now 601), along with certain alternative sensing devices used in additional embodiments of the present invention. Rather than sensing a power status indicating light, as was the case for device 304 of FIG. 3, a near-field or other communications tag device 641 aids a control unit (and comprised control system) in sensing actuation-relevant pressure, movement or other physical conditions relative to the main power button (now 605), and communicates signals related to such conditions wirelessly to a control unit (such as the control unit discussed with reference to FIGS. 4 and 5, above). In this way, the power and other electrical characteristics control techniques set forth above may be carried out wirelessly, and with less, or a different, visual and other physical impact on appliance 601.

Tag device 641 preferably comprises at least one adhesive aspect, such as a sticky pad, suction cup or magnet on the side of tag device 641 mounted on and facing the appliance 601. Such an adhesive aspect may be reversible, such that tag device 641 may be removed without substantial damage or residue on button 605, or may be more permanently binding, to improve adhesive performance. The various pressure-sensitive and other actuation-sensitive aspects and alternative embodiments of tag device 641 will be discussed in greater detail below, for example, with reference to FIGS. 10-20, but comprise embodiments where tag device 641 relays differing communications to the control unit depending on the relative position of compressible aspects of tag device 641, or depending on physical movement of tag device 641 as a whole, or depending upon surface contact (e.g., differences in galvanic resistance or capacitance) with tag device 641.

In some embodiments, an additional tag or communications hub 643 is included. Preferably, hub 643 is placed in the same relative movement frame of reference as tag device 641 (e.g., on the same appliance housing, as pictured), to more reliably assess differences in relative movement with tag device 641. Also preferably, hub 643 is placed closer to tag device 641 than the control unit. Both tag device 641 and hub 643 are able to communicate with either each other or the control unit, and, with the control unit, are able to assess changes in positioning between them relevant to the actuation, or the potential actuation, of button 605. For example, in some embodiments, a control unit issues wireless communications signals to both tag device 641 and hub 643, and receives return signals from each of them. In other embodiments, a control unit issues such signals via hub 643, to tag device 641. Based on the speed or strength of return signals from tag device 641 and hub 643, and Doppler effects, the control unit may then assess the relative distance from the control unit or hub 643 or other positioning of tag device 641 and, in some embodiments, of hub 643, and assess whether the button 605 is moving, and, in some embodiments, whether that positioning or the pattern of movement substantially matches actuation to switch on or switch off the appliance.

In some embodiments, hub 643 may also comprise at least one adhesive aspect, and may itself comprise a near-field or other communications tag. In others, hub 643 may be wired to the control unit, as was the case for the device embodiment pictured as 304, and may comprise a transmitter and/or receiver, with or without comprising such a tag.

FIG. 7 is a perspective drawing depicting an exemplary adhesive light-sensing device 701, such as the light-sensing device discussed above, in reference to FIG. 3, but depicted at greater magnification and in greater detail than depicted in FIG. 3. As mentioned with reference to adhesive light-sensing device 304, above, device 701 comprises an adhesive aspect, such as a sticky rim 703, which serves to mount device 701 on the housing 705 of an appliance. When mounted, preferably, device 701 is positioned such that it encircles and encloses an indicator light 707, comprised in the appliance within a dome or other space-defining volume 709 bounded and defined by device 701 and housing 705. A substantially translucent or transparent window or lens 711 is comprised in the upper portion of device 701, facing away from housing 705, and serves to permit light from indicator light 707 to escape from volume 709, and, in some embodiments, expands light 707's apparent size or intensity. But in any event, window or lens 711 allows at least some light from indicator light 707 (if emitted) to pass from volume 709, such that it is visible to a user.

Embedded in a housing or other structure 714 is a sensor or series of sensors 715, for detecting ambient light, light intensity levels, and other light characteristics (e.g., color) as may be necessary to assess the nature of status indications from indicator light 707. In the embodiment pictured, device 701 is able to detect the presence of light, light intensity levels, and other light characteristics both inside and outside of volume 709 (surrounding indicator light 707). For example, external ambient light sensor(s), such as the example pictured as 717, preferably are able to detect ambient light levels on the outside of device 701, while internal ambient light sensor(s), such as the examples pictured as 719, preferably are able to detect light levels within volume 709 and/or emanating from indicator light 707. Internal sensor(s) 719 may be directed toward, and focused on, indicator light 707, at the center of the circular surface area of housing 705 encompassed within structure 714 and sticky rim 703. Similarly, external sensor(s) 717 may be directed away from indicator light 707 and device 701, and toward the surrounding area, and some structure(s), such as opaque structure 714, may further serve to separate and aid in comparing different light sources, which separately sampled, at least by their amount or degree of sampling, by different sensors. In this way, internal sensor(s) 719 are able to take better-isolated readings of light emanating from indicator light 707, while external sensor(s) 717 are able to take better-isolated readings of ambient light levels external to device 701, with minimal, if any, light readings affected by indicator light 707. By comparing separate signals communicated from internal sensor(s) 719 and external sensor(s) 717 (for example, such signals carried via wire 713), a control unit, such as the control unit discussed above in reference to FIGS. 4 and 5, may determine when light, light levels, patterns and other light characteristics, or changes thereto, are being actively emitted by indicator light 707, because local light changes that more greatly and more immediately affect internal sensor(s) 719 than external sensor(s) 717 may be attributed to indications from light 707. In addition, when readings and corresponding signals of internal sensors 719 and external sensor(s) 717 each change in a substantially comparable way, or when light changes more greatly and immediately affect external sensor(s) 717 than internal sensor(s) 719, the control unit may determine that changed light conditions from internal sensor(s) 719 are the result of changed external light conditions, not light emission from indicator light 707.

FIG. 8 is another magnified perspective drawing depicting a different exemplary embodiment of an adhesive light-sensing device 801, such as the light-sensing device discussed above, in reference to FIG. 3. Among other things, device 801 differs from the embodiment shown as 701, above, in that external light sensors are omitted, and internal light sensors, alone, may adequately monitor and transmit signals representing the indication status of an encompassed indicator light (now 807). This capability is made possible by entirely substantially opaque structures encompassing an inner volume surrounding indicator light 807. Unlike with device 701, device 801 does not comprise a transparent or translucent lens through which light emanating from indicator light 807 may pass. Instead, device 801 comprises a separation wall 831, which, along with structure 814, encloses indicator light-surrounding volume 809 in an opaque shield. Because, if properly installed with rim 803 sealed and mounted on an appliance housing, no substantial ambient light may enter volume 809, accurate, isolated readings may be taken from an internal sensor 815, and the comparative analysis to correct for ambient light pollution from different sources, as discussed with reference to FIG. 7, above, is not necessary to signal a control unit accurately regarding readings of indicator light 807. Such signals again may be conveyed to a control unit via communication wire 813. Because the status indications from indicator light 807 are sealed within area 809, however, an auxiliary indicator light 833, mounted such that it is visible to a user, may be actuated by the control unit (via signals carried to light 833 by wire 813) to match, or otherwise correspond to, indications detected from indicator light 807.

FIG. 9 is another magnified perspective drawing depicting a different exemplary embodiment of an adhesive indicator- and actuation-sensing device 901, with some similar, and some new, functions in comparison to the light-sensing devices discussed above. As with other indicator-sensing device embodiments set forth in this application, device 901 is able to be mounted on the surface of an appliance housing 905, via adhesive aspects (e.g., sticky pads) 903. Rather than encircle and enclose an indicator, however, device 901 may be mounted adjacent to an indicator present in the housing 905, such as indicator light 907, as pictured. Device 901 comprises at least one sensor or camera 915, facing and focused at least partially in a direction perpendicular to the length of the device housing 914, and/or toward indicator light 907. In addition, in some embodiments (such as that pictured), device 901 comprises at least one other sensor or camera 917, facing and focused at least partially in another direction perpendicular to the length of housing 914, and/or toward a main power button 935 of the appliance. By virtue of such sensor(s) or camera(s), facing and focusing substantially in such directions, device 901 is able to monitor light levels and physical activity or changes in regions of space comprising indicator light 907 and/or button 935, and relay signals representing those levels, that activity or those changes, for example, via conductive leads 937 to a control unit (such as the control unit discussed with reference to FIGS. 4 and 5, above). In some embodiments, a signal interpreting and processing unit 939 may also, or alternatively, be included. Unit 939 serves to condition, process, filter or translate signals emanating from any or all of sensor(s) or camera(s) 915 and 917, prior to sending its own signals, resulting from such conditioning, processing, filtering or translation, to the control unit. Among other things, unit 939 can amplify, group, generalize, simplify, represent or convert signals that it receives, to improve their condition for transport via wire 913, or improve their ability to be processed and used by the control unit. In some embodiments, sensor(s) or camera(s) 915 and 917, either or both, may comprise lensing, a variable aperture, or other focusing and depth-of-field optimization means, such that device 901 may monitor and focus more on radiation emanating from a space better correlating with the activities of indicator light 907 and main power button 935. In some embodiments, each sensor or camera is optimized for the locations of indicator lights and buttons (or common, average, majority or other statistically-related to locations) of indicator lights or buttons, on appliances or classes of appliances. For example, a focal center and depth-of-field may be selected that encompasses 95% of indicator lights and main power buttons on appliances, when device 901 is installed in the center of the space between them, as pictured. In some embodiments, additional sensors, or just one sensor may be included, and less indicator lights or buttons (e.g., just one of them) may be monitored by device 901, which may focus in a different number of directions, such as one direction rather than two, with a different number of sensor(s) or camera(s) than set forth in FIG. 9.

As discussed in greater detail elsewhere in this application, based on monitoring readings and signals representing such readings by sensor(s) or camera(s) 915 and 917, a control unit may determine when an appliance has been switched off and switched on, among other conditions. In addition, the control unit may be programmed with recordings of light levels, patterns and changes, and record movements or terminal movement positions of button actuation, for identifying such conditions and taking further action (e.g., cutting main power to the appliance from the outlet when the appliance is determined to be actuated to be switched off).

FIG. 10 is a magnified perspective drawing depicting an exemplary embodiment of an adhesive button device 1001 comprising a new form of communications tag 1009, in accordance with aspects of the present invention. Button device 1001 comprises an outer housing 1000, which may be mounted on a control (such as a main power button) embedded in the housing of an appliance (as with device 641, mounted on button 605, above). Preferably, button device 1001 may be so mounted with a reversibly adhesive film 1002, which may be present on and line the outer surface of the bottom side of housing 1000. But a wide variety of alternative permanent or reversible adhesives and/or fasteners may be used, such as, but not limited to, at least one suction cup, magnet(s), or electrostatic device(s). As with a number of other temporary adhesion techniques, a peel-away protector 1003, with a removal-assisting tab 1004 and/or mount-assisting leash 1005 (also shown in an alternative, preferred position 1006 with dashed lines), that resists sticking to adhesive film 1002, is provided. Protector 1003 prevents errant sticking of adhesive film 1002 to objects other than the intended mounting surface, as a user removes protector 1003 for such mounting. With the embodiment including leash 1005, held in a position 1006, below the bottom of protector 1003, a user may hold unit 1001 in a desired mounting position while removing protector 1003, which will automatically curl and escape from under adhesive film 1002 (due to the pulling motion and/or camber in protector 1003) while exposing it to interface with the surface on which it becomes mounted.

Once mounted thereon, button device 1001 may serve as a proxy for a user interface control on the appliance, such as button 605, as discussed above. Button device 1001 comprises a flexible, compressible top surface 1007, which, when compressed downward, toward an appliance on which button device 1001 is mounted, indicates to the control unit that it has been actuated, and the control unit may take certain steps discussed elsewhere in this application (such as terminating, altering or providing power or other electrical characteristics from an outlet). As mentioned above, with reference to FIG. 6, a near field or other communications tag may be present in top surface 1007, and radar, telemetry or other position detection techniques may assess the state of compression (actuation) of top surface 1007, and take such steps based on those assessed movements. But, in the present embodiment, a different form of actuation-assessing communications hardware is used. In the embodiment pictured in FIG. 10, a new form of near field communications tag 1009 is provided, which is inactive unless and until a conductive bridging element 1011 is pressed against tag 1009, as occurs with sufficient compression of top surface 1007. Likewise, when a user ceases to press top surface 1007, it again rises due to its flexible resiliency, or a spring (not pictured), or another force-biasing device, and, as a result, removes bridging element 1011 from tag 1009, inactivating the tag. A wide variety of alternative embodiments may also, or alternatively, be used—such as a bridge or other member that inactivates a tag when compressed against it, or a member that is pushed away from contact with a tag when surface 1007 is compressed. The embodiment pictured is exemplary, not exhaustive, of the many alternatives falling within the scope of the invention.

FIG. 11 is a top-view drawing depicting elements of the new form of communications tag (now 1109) discussed with reference to FIG. 10, in greater detail, and separated from other aspects of the invention, for clarity. Tag 1109 comprises a substrate 1113, and may also comprise a protective housing (not pictured). An antenna 1115 is able, when tag 1109 is activated, to communicate with and (in passive tag embodiments) receive power from an external radio-frequency enabled device, such as control unit 401/501 or communications hub 643, discussed above (a “challenge device.”) A microchip or other local control device 1117, when connected with antenna 1115, may receive signals and may also issue unique signals (and signals in response to particular received signals) via antenna 1115. However, unlike with conventional RFID tags, tag 1109 remains in an inactive state, not so communicating via antenna 1115, unless and until a conductive bridge is formed between, on the one hand, one or both of input/output contacts 1119 of microchip or local control device 1117 and, on the other hand, antenna contacts 1121. As discussed above, a bridging element 1011, when pressed against the upper surface of tag 1009/1109, provides such an activating, conductive bridge. But unless and until such a conductive bridge is provided (for example, by actuation of device 1001 by sufficiently pressing its top surface 1007, conductive gaps 1123 prevent electrical signal transmissions between microchip or local control device 1117 and antenna 1115. In the embodiment pictured, plural bridgeable gaps 1123 are provided, with multiple microchip or local control device contacts 1119 and multiple antenna contacts 1121. However, it should be understood that less, or more such contacts, and bridgeable gaps may, alternatively, be used, and increase or decrease the ease or sensitivity of adhesive button device 1001. To maintain the gaps until actuation, while providing plural and variously-located contacts, insulating pieces, such as insulating piece 1125, may prevent contact between certain contacts while permitting them to be simultaneously present at some coordinate locations of a central plane of the communications tag, preventing errant conduction, such as short circuits.

FIG. 12 is a magnified top view depicting aspects of another exemplary adhesive button device 1201 comprising another new type of communications apparatus, in accordance with aspects of the present invention. Two flexible, resonant antenna elements, 1203 and 1205, are held in a place within a housing 1200, and housing lip 1207, to which they may be fastened. Antenna elements 1203 and 1205 each comprise a main resonant body (1209 and 1211, respectively), and a bridging section (1213 and 1215, respectively). Resonant antenna elements 1203 and 1205 may comprise a magnetic, acousto-magnetic, acoustic or other harmonic device that detectably responds to a received (“challenge”) wave, field or other signal by issuing returned waves or other signals as a result of sympathetic vibration or other physical reaction. For example, if a magnetic device is used, antenna elements 1203 and 1205 may comprise an amorphous metal with a magnetic saturation value leading it to differently respond to a range of magnetic field challenges (e.g., issued from control unit 401/501 or hub 643), enabling the control unit and comprised control system to detect the presence and resonant harmonic response of either or both elements, 1203 or 1205. Owing to vertical biasing of bridge sections 1213 and 1215, they are in direct physical contact when button device 1201 is not presently actuated by a user. However, when button device 1201 is actuated, bridge elements 1213 and 1215 are physically separated due to the action of aspects that will be discussed in greater detail below. Because the resonant harmonic response of antenna elements 1203 and 1205 will differ when they are in direct contact, in comparison to when they are out of direct contact, the control unit and comprised control system may assess the actuation state of button device 1201 based on the returned signal(s).

FIG. 13 is same magnified top view of the button device (now 1301) discussed immediately above, further depicting a push-button piece 1317 for actuating the device. Push-button piece 1317 is attached to the left-hand antenna element (now 1303) bridge section (now 1313) via bridge/button trusses 1319. When pressed downward (into the page) push-button piece 1317 therefore pushes bridge section 1313 downward until it is no longer in contact with bridge section 1315, above it. When released, however, push-button piece 1317 will again rise due to force biasing (for example, from a spring 1321 pushing against the lower side of bridge section 1313) pushing push-button piece 1317 and/or bridge section 1313 upward, and again coupling resonant antenna elements 1203 and 1205 (now 1303 and 1305).

In this simplified embodiment, additional housing and fastening techniques are omitted, but it should be understood that the housing, fastening and adhesion, and other aspects discussed with respect to any other actuation and indication monitoring device techniques set forth in this application may also be used in conjunction with this embodiment, or any other embodiment.

FIG. 14 is a top view of aspects of another exemplary adhesive button device, which also will be discussed with reference to additional, more complete, figures, below. In the figure, an inner housing 1400 is visible, and serves, along with protective walls 1402 and strip-holding lips 1404, as a mounting framework for a resonant strip 1403. As with the resonant antenna elements discussed above, with reference to FIGS. 12 and 13, resonant strip 1403 may comprise a magnetic, acousto-magnetic, acoustic or other harmonic device that detectably responds to a challenge wave, field or other signal by issuing returned waves or other signals as a result of sympathetic vibration or other physical reaction. In addition, it may respond with a number of simultaneous vibrational frequencies (e.g., tones), including a dominant tone, and harmonic tones. In the embodiment pictured in this figure, and in additional figures, below, frequencies or tones corresponding with a wavelength bounded at a node may be at least partially separated from at least one dominant tone, by muting at least part of that dominant tone at that node position.

FIG. 15 is a side view depicting a damping piece 1501, for muting dominant or other selected tones from a resonant strip within the adhesive button device discussed with reference to FIG. 14, and with reference to further figures, below. Damping piece 1501 comprises a flexible, soft damper 1503 and mounting poles 1505. When damping piece 1501 is mounted, mounting poles 1505 are seated and able to travel vertically within pole receivers 1405 (shown in FIG. 14, above) aligning soft damper 1503 with a central position along the length of strip 1403. Force biasing, such as springs 1407 within receivers 1405, lead damping piece 1501 ordinarily to be raised above strip 1403, and, as a result, damper 1503 is not in contact with strip 1403. However, if pressed downward when so mounted (into the page, with reference to FIG. 14) damper 1503 contacts strip 1403 in a terminal, actuated position that mutes (at least, when strip 1403 is sufficiently vibrating) certain dominant tones produced by strip 1403, while more greatly retaining other tones produced in response to a challenge from a control unit or hub (as discussed above).

FIG. 16 is a perspective view of additional aspects of the button device (now 1601) discussed with reference to FIGS. 14 and 15 and with reference to additional figures, below. In this figure, the mounted position of mounting poles 1505 (now 1605) are pictured, without the remainder of damping piece 1501, from a new angle. Also pictured is a main housing section 1600, enclosing inner housing 1400 (now 1640) and several other elements of the button device previously discussed with reference to FIG. 14. In this figure, however, springs 1407 are omitted, and may be omitted in certain embodiments where force biasing from another source (such as a compressible top section of the button device, which will be discussed in further detail below) is present and aids in elevating poles 1605 and damper 1503 away from resonant strip 1403, unless and until its upper, push/transmission piece 1551, to which damper 1503 is attached, is pressed downward.

FIG. 17 is in the same perspective as FIG. 16 and depicts the same aspects of a button device (now 1701) discussed with reference to FIGS. 14-16, with additional elements of damping piece 1501 (now 1750) also installed. Specifically, a push-transmission piece 1751 is now shown, which corresponds with 1551, of FIG. 15. Push-transmission piece 1551/1751 serves as a platform for the soft damper (now 1703) and comprises a round surface for absorbing force from above, and translating that force into downward motion against springs or other force loading (not pictured).

FIG. 18 depicts the same button device (now 1801) depicted in FIGS. 14-17, in a more complete state, including a flexible, compressible top surface 1870. Compressible surface 1870 permits a user to actuate button device 1801 by compressing it, exerting downward force on transmission piece 1871, lowering damper 1803 onto strip 1830, and muting certain resonant vibrations or frequencies emitted therefrom. A label 1880 may be provided to indicate the function of button device 1801 to a user. As mentioned above, top surface 1870 may comprise a force-biasing material or structure, such as flexible spring ribs 1890, and the movement of a part of top surface 1870 may be aided by grooves or joints in the material, such as joint 1895. Top surface 1870 may be attached to transmission piece 1871, causing it to rise, along with surface 1870, when released from compression, and thus permitting the resonant strip 1830 to emit dominant tones once again.

FIG. 19 is a perspective view of an additional form of adhesive button device 1901, which may operate by touch-capacitance or touch-resistance actuation. As with the other button devices set forth above, button device 1901 may operate to communicate with a control unit, such as control unit 401/501, and a comprised control system, to indicate actuation states, or intended actuation states, of an appliance on which device 1901 is mounted.

Button device 1901 comprises several generally rectangular shallow box-shaped layers of materials. Outer-most (at the top of the figure) is a protective, transparent film layer 1903, which absorbs pressure and prevents damage to underlying layers (lower down, in the perspective of the figure). Next downward is an adhesive, separation layer 1905, which serves to bind the protective layer 1903 to further elements of device 1901, and isolates those elements from undesired interactions with the environment. Finally, transparent capacitive conductors (such as, but not limited to, deposits of iridium tin oxide) are comprised within a lower layer 1907, and electronically connected via lead(s) 1908 to a local control unit 1909, via a corner contact 1911. Local control unit 1909 may thus detect changes in capacitance by objects in contact with layer 1903 through lead 1908, corner contact 1911, and conductive deposits on layer 1907, and translate those changes into signals sent to a main control unit (such as control unit 401/501), which that main control unit may interpret and take further actions based upon, as discussed elsewhere in this application. Preferably, local control unit 1909 includes a control system and may include a wireless transmission antenna, or other communications techniques, such as the wired and wireless communications devices discussed above for tags, light-sensing devices and control units discussed above. An exemplary control system is discussed below, in reference to FIG. 23. Local control unit 1909 may also comprise an indicating light, such as a light-emitting diode 1913, which permits adhesive button device 1901 to indicate actuation states of itself, the main control unit, and/or other useful information, to a user.

FIG. 20 is perspective view depicting a set 2001 of adhesive button devices 2003, which may each be similar in nature to the adhesive button device discussed with reference to FIG. 19, above. Adhesive button devices 2003 may be mounted on or within a tape platform 2005, which may comprise an adhesive, fastening or other attachment aspect 2007, on its lower side. Such an adhesive, fastening or other attachment aspect 2007 may comprise a reversible sticky layer, or other techniques for device adhesion, fastening and attachment discussed elsewhere in this application. In addition, tape platform 2005 may comprise periodic etching or scoring, such as the example pictured as 2009, which eases separation (breaking apart, if desired) of segments 2011 of the tape platform. Preferably, each such segment 2011 contains or is mounted to one adhesive button device 2003 such that, when manually broken apart by a user, button devices 2003 are better supported, each with a dedicated segment of tape platform.

In other embodiments, multiple rows and columns of button devices may be commonly held in a set, with scoring in multiple directions. In others, aligned columns, rows or segments are not used, and a more random or differently-patterned arrangement of button devices may be used, with or without scoring. In embodiments without scoring, a certain number of button devices may be sacrificed upon tearing a length of tape platform and part of the set of button devices, if resultantly decoupled or otherwise damaged. Although not pictured, for clarity, any number of additional, protective, variably-conjoining, and/or sensory device-comprising layers, or sets thereof (such as additional instances of the pictured layers, further layered onto one another in a complementary, scoring-aligned position) may also be provided, in addition to the layers pictured in the figure. For example, an upper, unifying tape platform/protective layer, comprised of the same material(s) as sections 2011, may also further protect the upper surfaces of the devices 2003, while permitting conductive or resistive transmissions to them from manual (e.g., digital) actuation. Such a layer may periodically merge with, and share features, such as scoring 2009, with sections 2011, and the lower tape platform, generally.

FIG. 21 is a process flow diagram depicting exemplary steps 2100 which may be executed by a control system, such as the control system discussed below, with reference to FIG. 23, implementing exemplary programming, methodology and other aspects of the present invention. As with other process flow diagrams set forth in this application, the steps set forth herein are exemplary only, and not exhaustive of the various differing approaches that fall within the scope of the invention. The control system carrying out these and other process steps set forth in this application may be comprised in a control unit (such as control unit 401/501, set forth above) in communication with peripheral indication and actuation monitoring and controlling hardware, as set forth elsewhere in this application. An exemplary control system, which comprises hardware and software, is set forth below, with reference to FIG. 23.

Beginning with step 2101, the control system may first assess whether a Main Power control of the control unit, such as Main Power Button 414, set forth above, has been switched on, and/or, if power from an associated outlet is presently being provided to an appliance plugged into (or otherwise configured to receive power from) the control unit, by the control unit in which the control system is comprised. If so, the control system may proceed to step 2103, in which the system may determine whether the Appliance “on” Indicator/Button of the control unit (e.g., indicator/button 415), for programming the control unit to save readings as appliance “switched on”-associated readings, has been depressed. If so, the control system may proceed to step 2105, in which, depending on the embodiment of the control unit and associated peripheral devices for monitoring actuation, actuation indicators, and control actuation (such as those discussed in reference to FIGS. 3 and 6-20), it monitors and records subsequent detected substantial, and substantially concurrent, changes in indicator light illumination, appliance power control position, control movement, tag movement, tag position, tag activation, electrical characteristics (such as power, current, voltage or EMF) and/or patterns thereof and associates the resulting recordings with the appliance being “switched off.” In some embodiments, the control system may discontinue such recordings upon such indications, actuation and patterns ceasing. In others, all such indications, actuation and patterns may be recorded for a predetermined length of time after they begin, and must be a great or significant enough movement, change, or pattern thereof to begin the recording. In still other embodiments, a user may be required to actuate a control to indicate that recording shall begin and/or end.

Next, the control system proceeds to step 2107, in which it uses the same peripheral hardware (varying depending on the embodiment) and determines whether readings taken match those recorded in step 2105 (indicating that the appliance has been “switched off.” If such a match is detected, the control system may proceed to step 2109, in which it halts or otherwise limits or controls power delivery from the outlet in which it is installed and/or to the appliance, via a switch interrupting such power delivery (e.g., in conductors to the control unit's own socket, such as 411). The control system next may proceed to step 2111, in which it continues to monitor, using the same peripheral hardware, indicator, actuation and/or electrical characteristics activities, and determines whether readings presently taken substantially match those recorded indicating that the appliance has been “switched on” (as discussed further in reference to step 2121) and, if such a match is made, the control unit supplies power from the outlet to the appliance in step 2113—for example, by actuating switches allowing conduction from the outlet to the control unit socket in which the appliance is plugged. As mentioned above, a sensitivity adjustment to the control unit settings may be made by a user, to alter, for example, the substantiality of the match required to cause such action by the control unit. After step 2113, or if no such match is made, in step 2111, the control system may then return to the starting position.

Returning to step 2101, if Main Power is not being provided to an appliance from the outlet in which the control system is mounted, by the control system, the control system may proceed to step 2115 in which, as in step 2103, it determines whether an Appliance “on” Indicator/Button of the control unit (e.g., indicator/button 415), for programming the unit to save readings as appliance “on”-associated readings, has been depressed, and, if so, the control system provides full power from the outlet in which it is installed to the appliance (if any) associated with the control unit—e.g., plugged into the control unit's socket—in step 2117. As in step 2103, the control system may next proceed to steps 2105 et seq.

If in step 2103 or step 2115 the control system determines that the Appliance “on” indicator button has not been depressed, it may determine, in step 2119, if the Appliance “off” indicator button of the control unit (e.g., indicator/button 417), for programming the unit to save readings as appliance “off”-associated readings, has been depressed. If so, the control system proceeds to step 2121 in which, depending on the embodiment of the control unit and associated peripheral devices for monitoring actuation, actuation indicators, and control actuation (such as those discussed in reference to FIGS. 3 and 6-20), it monitors and records subsequent detected substantial, and substantially concurrent, changes in indicator light illumination, appliance power control movement, control position, tag movement, tag position, tag activation, electrical characteristics (such as power, current, voltage or EMF) and/or patterns thereof and associates the resulting recordings with the appliance being switched on. The control system may then proceed to steps 2107 et seq., as discussed above.

FIG. 22 is another process flow diagram depicting additional exemplary steps 2200 that may be executed by a control system, such as the control system discussed below, with reference to FIG. 23, implementing exemplary programming, methodology and other aspects of the present invention. More specifically, FIG. 22 depicts steps for such a control system establishing and implementing a minimum operational power standard. As mentioned, for example, with respect to FIG. 4, above, in some embodiments, a control unit controlling the distribution of power from a power outlet to an appliance may reduce the distribution of power or other electrical characteristics based on a minimum operational standard. Further, as also discussed with reference to FIG. 4, such a control unit may determine such a minimum operational standard by dialing down power until sensing a non-operational or adverse condition. FIG. 22 provides greater detail concerning these aspects of the invention, and steps that may be carried out by a control system comprised in such a control unit.

Beginning with step 2201, the control system first determines whether the control unit is delivering substantial, operational power to an appliance. If so, the control system proceeds to step 2203, in which it senses and/or records at least some operational characteristic of the appliance (or patterns thereof, over time). For example, in some embodiments, sensory hardware may sense and record such operational characteristics as current, voltage, resistance, power level, energy consumption, or load (or patterns of any of these electrical characteristics over time) of the appliance or circuit of which the appliance is a part and associate those recordings with the appliance's operation at the power level provided by the control unit. In some embodiments, the initial power level provided in step 2201, and associated operational characteristics recorded in step 2203, relate to the level of voltage, and resulting power consumption by the appliance, resulting from or matching the voltage and other characteristics of the power outlet, which are initially applied to the appliance by the control unit. In other embodiments, however, a lower or higher voltage or power level may be implemented in these steps. If no power is presently being provided to the appliance by the control unit, in step 2201, the control system may return to the starting position until such time that a user, control system or the appliance causes the control unit to provide such power.

After sensing and recording operational electrical characteristics, in step 2203, the control system proceeds to step 2205, in which it provides a new power or other electrical characteristics level(s), or pattern thereof, to the appliance. If a voltage and resulting power level of or above that of the power outlet are provided in step 2201, as discussed above, the altered voltage (or other electrical characteristics level(s)) provided in step 2205 is preferably substantially below those resulting at the voltage and power level of the power outlet. But, in some embodiments, and, particularly, where a lower initial voltage and power level are used in step 2201, the altered voltage (or other electrical characteristics level(s)) provided in step 2205 may be substantially above those resulting at that lower initial voltage and power level. The control system then proceeds, in step 2207, to sense and/or record new levels and/or patterns of the types of operational characteristics of the appliance recorded previously in step 2203 and associates those recordings with the appliance's operation at that altered voltage (or other electrical characteristics). Following those recordings, in step 2209, the control system proceeds to assess whether the new power or other electrical characteristics level(s) (or pattern thereof) provided to the appliance in step 2205, have potentially resulted in an alteration of the appliance's operational characteristics. For example, if a lower voltage, current and/or power level is provided to the appliance in step 2205, the control system may assess whether the load, resistance, current and patterns thereof have fallen to a degree or in a pattern matching, proportionally matching, or otherwise relating to the tested increment or pattern of change (e.g., in voltage, current or power level), or following implementation of the tested increment or pattern at a time matching the power consumption cycle, and power-consumption lag, of the appliance, which may be assessed in other testing of the appliance. If the new power or other electrical characteristics level(s), or pattern thereof, provided to the appliance have potentially resulted in an alteration of the appliance's operational characteristics, the control system proceeds to step 2211, in which it further determines whether the alterations in the appliance's operational characteristics indicate a substantial impact on the appliance's performance, based, for example, on sensed energy consumption levels, load drawn, patterns thereof, or other alterations in the appliance's operational characteristics no longer matching levels and patterns for a properly functioning appliance, or, conversely, based on a sensed load drawn that matches levels and patterns for an improperly functioning appliance. If there is such a substantial impact on performance, the control system proceeds to step 2213, in which it may decrease and otherwise vary the tested reduction of voltage or other electrical characteristic(s), or of net levels of a pattern or pattern type thereof, and returns to step 2207. If there is no such substantial impact on performance, in step 2211, the control system proceeds to step 2215, in which it may determine whether there is any improvement in efficiency, in terms of power drawn or otherwise used by the appliance, or in the delivery of power or other electrical characteristics by the outlet, appliance or control unit, due to the latest increment or pattern of changed, provided electrical characteristics tested in steps 2207 et seq. If not, or if, in step 2209 there were no coinciding alterations in the appliances operational characteristics, the control system proceeds to step 2217, in which it may increase and otherwise vary the tested reduction of voltage or other provided electrical characteristic(s), or of a pattern or pattern type thereof, and returns to step 2207. If, however, there is a corresponding improvement in efficiency in step 2215, the control system may proceed to step 2219, in which it proceeds to record efficiency-related metrics, such as the amount of power use reduction due to the latest increment or pattern of changed, provided electrical characteristics tested in steps 2207 et seq. The control system may then proceed to step 2221, in which it compares those metrics to previously-recorded metrics for previously-tested increments or patterns of changed, provided electrical characteristics so tested. If that comparison indicates an improvement in efficiency (a greater electrical characteristics or other cost savings) over the most efficient previously tested increment or pattern, in step 2223, the control system may proceed to step 2225, in which it assesses whether there has been sufficient testing to substantially cover possible increments or patterns of changed electrical characteristics or ranges thereof, such that further testing will not produce a superior efficiency, or is not sufficiently likely to produce a superior efficiency, to justify the costs of further testing. If testing is insufficient, under such an optimization analysis, the control system may return to step 2217. If testing is determined to be sufficient, the control system may proceed to step 2227, and implement the electrical characteristics corresponding with the most efficient tested increment or pattern, until the control unit is switched off or disconnected, or the appliance is switched off or disconnected, or another interruption in service or performance by the appliance is sensed or assessed. If so, the control system proceeds to step 2229, and further determines whether the appliance is sensed to incur a significant performance-altering or other critical event, such as a load indicating a failure of the appliance to operate properly, based on previously-recorded operational or non-operational data, in which case, the control system may record a failure event (substantially impacting appliance performance) for the latest, most efficient implemented characteristics, designate those characteristics as substantially affecting appliance performance, cancel or erase recordings of those characteristics, in step 2231, and return to the starting position (or, in some embodiments, step 2213). If a significant performance-altering or other critical event is not determined to have occurred in step 2229, the control system may return to step 2227.

As mentioned above, the electrical characteristics provided in step 2205 may be conducted in increments, which may iterate or otherwise change in subsequent cycles through step 2205 et seq. Such tested increments may be applied by the control system in stepped increments or intervals, including integrated, overall, average, range, limits or other intervals for increments of successively-tested patterns, to determine an optimal level of such characteristics which do not adversely impact the performance of the appliance, but reduce the voltage, power consumption and other inefficiencies or electrical characteristics of the circuit of which the appliance is a part. In some embodiments, a larger increment or interval of changed electrical characteristics may be tested initially, followed by smaller (“fine-tuning”) intervals. A failed interval (e.g., too great an increment) which may be followed by a split difference, or other directionally-selected, optimal level selection-aiding and range-narrowing intervals, may also, or alternatively, be implemented.

FIG. 23 is a schematic block diagram of some elements of an exemplary control system 2300 that may be used in accordance with aspects of the present invention, such as, but not limited to, monitoring indication, actuation and operational conditions of appliances, and controlling the provision of power and other electrical characteristics through hardware and peripheral devices of a control unit. The generic and other components and aspects described herein are not exhaustive of the many different systems and variations, including a number of possible hardware aspects and machine-readable media that might be used, in accordance with the present invention. Rather, the system 2300 is described to make clear how aspects may be implemented. Among other components, the system 2300 includes an input/output device 2301, a memory device 2303, storage media and/or hard disk recorder and/or cloud storage port or connection device 2305, and a processor or processors 2307. The processor(s) 2307 is (are) capable of receiving, interpreting, processing and manipulating signals and executing instructions for further processing and for output, pre-output or storage in and outside of the system. The processor(s) 2307 may be general or multipurpose, single- or multi-threaded, and may have a single core or several processor cores, including, but not limited to, microprocessors. Among other things, the processor(s) 2307 is/are capable of processing signals and instructions for the input/output device 2301, analog receiver/storage/converter device 2319, analog in/out device 2321, and/or analog/digital or other combination apparatus 2323 to cause a display, light-affecting apparatus and/or other user interface with active physical controls, such as indicator buttons and displays, and control actuation monitoring hardware, any of which may be comprised or partially comprised in a GUI, to be provided for use by a user on hardware, such as a specialized personal computer monitor or PDA (Personal Digital Assistant) or control unit screen (including, but not limited to, monitors or touch- and gesture-actuable displays) or a terminal monitor with a mouse and keyboard or other input hardware and presentation and input software (as in a software application GUI), and/or other physical controls, such as a button, knob or LEDs for determining appliance conditions or statuses or related circuit or other characteristics. Alternatively, or in addition, the system, using processors 2307 and input/output devices 2319, 2321 and/or 2323, may accept and exert passive and other physical (e.g., tactile) user, power supply, appliance operation, user activity, circuit and environmental input (e.g., from sensors) and output.

For example, and in connection with aspects of the invention discussed in reference to the remaining figures, the system may carry out any aspects of the present invention as necessary with associated hardware and/or using specialized software, including, but not limited to, controlling the provision of power and electrical characteristics from an outlet to an appliance, with a control unit and/or wireless network. The system may also, among many other things described for control systems in this application, respond to user, sensor and other input (for example, by a user-actuated GUI controlled by computer hardware and software or by another physical control) to issue alerts, alter settings, control the conduction of current and power from a cell upon detecting critical condition(s), monitor operative conditions and electrical characteristics of an appliance and a circuit in general, or perform any other aspect of the invention requiring or benefiting from use of a control system. The system 2301 may permit the user and/or system-variation of settings, including but not limited to the affects of user activity on modes of operation of the system, and send external alerts and other communications (for example, to users or other administrators) via external communication devices, for any control system and control unit aspect that may require or benefit from such external or system-extending communications.

The processor(s) 2307 is/are capable of processing instructions stored in memory devices 2303 and/or 2305 (and/or ROM or RAM), and may communicate with any of these, and/or any other connected component, via system buses 2375. Input/output device 1301 is capable of input/output operations for the system, and may include/communicate with any number of input and/or output hardware, such as a computer mouse, keyboard, entry pad, actuable display, networked or connected second computer or processing device, control unit, other GUI aspects, camera(s) or scanner(s), sensor(s), sensor/motor(s), actuable electronic components (with actuation instruction receiving and following hardware), RF antennas, other radiation or electrical characteristics reading, monitoring, storage and transmission affecting hardware, as discussed in this application, range-finders, GPS systems, receiver(s), transmitter(s), transceiver(s), transflecting transceivers (“transflecters” or “transponders”), antennas, electromagnetic actuator(s), mixing board, reel-to-reel tape recorder, external hard disk recorder (solid state or rotary), additional hardware controls (such as, but not limited to, buttons and switches, and actuators, current or potential applying contacts and other transfer elements, light sources, speakers, additional video and/or sound editing system or gear, filters, computer display screen or touch screen. It is to be understood that the input and output of the system may be in any useable form, including, but not limited to, signals, data, commands/instructions and output for presentation and manipulation by a user in a GUI. Such a GUI hardware unit and other input/output devices could, among other things, implement a user interface created by machine-readable means, such as software, permitting the user to carry out any of the user settings, commands and input/output discussed above, and elsewhere in this application.

2301, 2303, 2305, 2307, 2319, 2321 and 2323 are connected and able to communicate communications, transmissions and instructions via system busses 2375. Storage media and/or hard disk recorder and/or cloud storage port or connection device 2305 is capable of providing mass storage for the system, and may be a computer-readable medium, may be a connected mass storage device (e.g., flash drive or other drive connected to a U.S.B. port or Wi-Fi) may use back-end (with or without middle-ware) or cloud storage over a network (e.g., the internet) as either a memory backup for an internal mass storage device or as a primary memory storage means, and/or may be an internal mass storage device, such as a computer hard drive or optical drive.

Generally speaking, the system may be implemented as a client/server arrangement, where features of the invention are performed on a remote server, networked to the client and facilitated by software on both the client computer and server computer. Input and output devices may deliver their input and receive output by any known means of communicating and/or transmitting communications, signals, commands and/or data input/output, including, but not limited to, input through the devices illustrated in examples shown as 2317, such as 2309, 2311, 2313, 2315, 2376 and 2377 and any other devices, hardware or other input/output generating and receiving aspects—e.g., a PDA networked to control a control unit 2377 with the aid of specialized software (a.k.a. a “PDA Application” or “App.”). Any phenomenon that may be sensed may be managed, manipulated and distributed and may be taken or converted as input or output through any sensor or carrier known in the art. In addition, directly carried elements (for example a light stream taken by fiber optics from a view of a scene) may be directly managed, manipulated and distributed in whole or in part to enhance output, and radiation or whole ambient light or other radio frequency (“RF”) information for an environmental region may be taken by a photovoltaic apparatus for battery cell recharging, or sensor(s) dedicated to angles of detection, or an omnidirectional sensor or series of sensors which record direction as well as the presence of electromagnetic or other radiation. While this example is illustrative, it is understood that any form of electromagnetism, compression wave or other sensory phenomenon may become such an “ambient power” source harnessed to power the operations of a control unit and/or control system and/or may include such sensory directional and 3D locational or other operations-identifying information, which may also be made possible by multiple locations of sensing, preferably, in a similar, if not identical, time frame. The system may condition, select all or part of, alter and/or generate composites from all or part of such direct or analog image or other sensory transmissions, including physical samples (such as DNA, fingerprints, iris, and other biometric samples or scans) and may combine them with other forms of data, such as image files, dossiers, appliance-identifying files, or operations-relevant recordings, or metadata, if such direct or data encoded sources are used.

While the illustrated system example 2300 may be helpful to understand the implementation of aspects of the invention, it should be understood that any form of computer system may be used to implement many control system and other aspects of the invention—for example, a simpler computer system containing just a processor (datapath and control) for executing instructions from a memory or transmission source. The aspects or features set forth may be implemented with, as alternatives, and/or in any combination, digital electronic circuitry, hardware, software, firmware, or in analog or direct (such as electromagnetic wave-based, physical wave-based or analog electronic, magnetic or direct transmission, without translation and the attendant degradation, of the medium) systems or circuitry or associational storage and transmission, any of which may be aided with enhancing media from external hardware and software, optionally, by wired or wireless networked connection, such as by LAN, WAN or the many connections forming the internet or local networks. The system can be embodied in a tangibly-stored computer program, as by a machine-readable medium and propagated signal, for execution by a programmable processor. The method steps of the embodiments of the present invention also may be performed by such a programmable processor, executing a program of instructions, operating on input and output, and generating output. A computer program includes instructions for a computer to carry out a particular activity to bring about a particular result, and may be written in any programming language, including compiled and uncompiled, interpreted languages, assembly languages and machine language, and can be deployed in any form, including a complete program, module, component, subroutine, or other suitable routine for a computer program.

FIG. 24 is a front view depicting an appliance-sensing, and -actuating and control unit peripheral device 2401 next to an appliance 2400, on which device 2401 may be installed by a user. As will be explained in greater detail below, device 2401 comprises system-controlled actuators, which may depress (and therefore actuate) a button on an appliance, such as, but not limited to, button 2403. However, it should be understood that the appliance-actuating device type and form presented in FIG. 24 are exemplary only, and a wide variety of additional button or other control-actuation devices may also, or alternatively, be implemented while still falling within the scope of the invention. For example, a switch- or dial-actuating device may be used, rather than, or in addition to, the button-actuating form depicted in FIG. 24. As another example, rather than actuating such an appliance control, device 2401 may send a wireless command signal to appliance 2400, if it is so actuable by wireless signals, to cause any of the power or other actuation commands carried out using a physical control, as set forth below. Furthermore, as discussed above in reference to FIG. 4, a control unit communicating with peripheral device 2401 may cause any of the actions and steps set forth below to occur as the result of wireless communications or other external information and statuses related to actuation of the appliance (e.g., an appliance remote control signal ascertained or intercepted by the appliance) in addition to issuing wireless signals to actuate the appliance. A standardized communication protocol or other technique may be used to address, and specifically address, such communications needs between appliances, control units and other, peripheral devices, networks and controls carrying out aspects of the present invention.

To install device 2401, a user may position a generally round section 2404 of the housing 2405 of device 2401 over button 2403, and then press section 2404 against the housing 2408 of the appliance 2400. In so doing, a user may fix a flexible and sticky, or otherwise fastening appliance-facing surface 2407 to the outer surface of the appliance housing 2408 surrounding button 2403, thereby fixing and properly installing device 2401 onto appliance 2400.

Once properly installed, device 2401 may also be connected for communications with, and controlled by, a control unit comprising a control system, such as the control unit discussed with reference to FIGS. 4 and 5, above. As mentioned above, in some embodiments, such a control unit may communicate with, power, or be powered by, control and be controlled by peripheral devices, such as device 2401, via wireless communications and power delivery techniques. However, in other embodiments, device 2401 may transmit or receive power, control or be controlled by and communicate with a control unit via a wired connection. In one such embodiment, as pictured, an extending communications and/or power transmission wire 2413 is provided, and may be variably connected with a control unit (connected and disconnected at the election of the user and/or system) via a connection plug 2411, which may be engaged or disengaged with a complementary connection port comprised in or on the control unit (not pictured). Such a variable connection plug and port may take on a form comprising or compliant with standardized formats and communications protocols, such as the Universal Serial Bus (“U.S.B.”) standard, but may also, or alternatively, comprise a dedicated communications structure and protocol, or simpler electronic power and signal transmission wiring or connections.

If connected with a control unit for electronic power and communications transmission, and if properly installed onto appliance 2400, device 2401 may operate to detect actuation, actuation state, power usage states, and other conditions of appliance 2400, for example, by detecting indications from main power indicator light 2409 via a light sensor 2415—as, for example, the indication-detecting device 901 of FIG. 9 so detected the indications of an indicator with its sensor 915, as discussed above. A directional indicating label or guide such as line 2416 may aid the user in aligning the sensor 2415, such that it is aimed toward (focusing its detecting capabilities on) an indicator light such as 2409. Preferably, sensor 2415 is pivotable or otherwise movable relative to device housing section 2404—for example, via a turret joint—such that a user may adjust the direction of sensor 2415 after installation of device 2401. But, in some embodiments, sensor 2415 is fixed (or fixed with the exception of permitted rotational motion) to housing 2405. By detecting various conditions of appliance 2400, device 2401 and an associated control unit may carry out various safety and efficiency-improving operations, such as those discussed above in connection with other indication-, actuation- and other condition-sensing devices, control units and control systems set forth in this application. In addition, device 2401 may carry out several additional useful operations, which will be discussed in greater detail, for example, with reference to the process flows discussed with reference to FIG. 28, below. By way of example, device 2401 may, in some embodiments, control actuation of button 2403 and power provision from a power source, such as a power outlet, to the appliance, both in response to actuation commands from a user and according to programming, which also may be varied and optimized through testing and use experience and user commands. In some embodiments, a proxy power button 2417 is provided which, when properly installed, is located in a related or similar position to the button 2403, over which it is installed. The proxy power button 2417 permits a user to indicate, for example, that she or he wishes to actuate the main power control of the appliance 2400. In addition, user programming controls, such as a Set button 2419 may be provided as part of a user interface, in some embodiments of the invention. By depressing Set button 2419, a user may indicate that she or he is currently, or next will, carry out another action (such as depressing proxy button 2417, or actuating appliance 2400) that should be associated by the control unit with a particular power use state or power use state transition, such as the device being turned off (as indicated by button label 2421). Device 2401 may also comprise an extending handle 2423, which aids in installing device 2401, that may comprise some user interface control aspects, such as Set button 2419, and may flexibly or otherwise conform to a wide variety of possible appliance housing contours, such as contour 2425 for example, by bending relative to mounted section 2404 via a joint 2424, which may be force-biased toward bending. This and other aspects discussed above will be better understood with reference to FIG. 25, and other figures, below.

FIG. 25 is a sectional side view depicting additional exemplary aspects of the same peripheral device (now 2501) discussed with reference to FIG. 24, above. The sectional view presented represents a lengthwise (in the direction indicated by plane-indicating arrow A of FIG. 24) and vertical (along a plane out of and into the page, within the perspective of FIG. 24) division of device 2401, such that the inside of one of the two resulting, equal halves from the division is visible. From this side, sectional view, two exemplary angles of flexible joint 2524, between handle 2523 and generally round housing section 2504, are pictured: Position 2574 and position 2575. In practice, a wide variety of differing angles between handle 2523 and section 2504 are possible, and positions 2574 and 2575 are exemplary flexed degrees of joint 2524 only. Position 2574, resulting in an angle of 180 degrees (or, a “flat” conformation) between handle 2523 and section 2504, may approximately occur when device 2501 is installed onto an appliance housing that is substantially flat. Position 2575, by contrast, comprises a bent conformation of device 2501, and may result when device 2501 is installed onto an appliance housing part with certain curved or otherwise non-flat contours, such as that pictured as 2425 of FIG. 24. To cause or maintain an optimal conformation of joint 2524 when installed onto a particular appliance, joint 2524 may comprise a force-biasing and/or angle-movement fixing or resisting device, such as a spring and/or flexible and bendable metal member, or ratchet.

Proxy button 2517 is now shown depressibly mounted within section 2404/2504, and comprises a space-saving hollow 2531. Occupying at least part of that hollow 2531 is a proxy button actuation sensor device 2533, comprising a depressible piece 2535, housed in a depression travel channel 2537, and depression detection sensors (not pictured). Independently actuable from proxy button 2517 is an appliance button actuating piece 2541, which also may travel vertically in a channel 2543 via a vertical-movement actuator/motor 2545, which may move a push rod 2548, which is attached to piece 2541, up and down, to actuate an appliance button over which device 2501 is installed. As discussed above, flexible sticky, or otherwise fastening appliance-facing aspects (now 2507) aid in mounting section 2504 onto an appliance, but do not interfere with the operation of button actuating piece 2541 because they rim the location of a button over which section 2504 is mounted. Also within section 2504 is a local processor or control unit 2547, which, in some embodiments, may aid in assessing actuation positions of both proxy button 2517 and button-actuating piece 2541, and may aid in communications, power and other operations, along with or instead of a control system within a control unit and also carrying out some or all of the functions of such a control system within a control unit, as discussed in various embodiments above. To prevent stress and slippage, button-actuating piece 2541 may be shaped with flexible arms 2549 and ridges 2550. With these aspects, even a misaligned section 2504, installed off-center over an appliance button, tends to hold its position during actuation and maintain contact with an appliance button, without twisting, relative to the appliance button and appliance housing, and still may be capable of actuating the appliance button.

FIG. 26 is a perspective view depicting certain mechanical aspects of a toggle-style electrical switch 2601, without a cover plate. This figure will serve as a platform for discussing further power control actuation techniques in accordance with aspects of the present invention discussed below. Although aspects of a toggle-style switch 2601 are depicted, it should be understood that a wide variety of alternative power delivery controls may be actuated in accordance with aspects of the present invention as discussed herein, and the embodiments depicted are exemplary only. The exemplary electrical switch 2601 comprises several components and aspects found in some electrical switches, including, but not limited to a manually (by digit) actuable toggle 2603 and mounting plate 2605. Toggle 2603 may be pushed into at least two positions: an off position, and an on position (pictured). As pictured, in the on position, toggle 2603 permits electrical power and/or other electrical characteristics to flow in an electrical circuit. When flipped downward, into the off position (not pictured), toggle 2603 terminates at least some electrical contacts, preventing the flow of power, current or at least some electrical characteristics through such a circuit. Certain sections of mounting plate 2605, such as sections 2607, may be more recessed (to the right and into the page, in the perspective of the figure) than the remainder of mounting plate 2605, creating a void below a cover plate, if and when such a cover plate (not pictured) is installed over switch 2601. Switch 2601 may be fastened to a wall, or a structure located within a wall, via screw ports such as those examples shown as 2609. In addition, cover plate-fastening screws 2611 are also depicted, and installed in fastening ports 2613 within mounting plate 2605.

FIG. 27 is a view from the same perspective as FIG. 26, above, of the same electrical switch (now 2701) and an additional switch actuation device 2702 installed onto it, in accordance with aspects of the present invention. As with peripheral device 2401, discussed above, device 2702 may be connected for communications with a control unit, such as one of the control units and/or control systems discussed above, for example, via a wireless communications antenna 2715 or a wired connection (not pictured). However, in some embodiments, a separate control unit or control system is not used and, instead, a local control system, such as C.P.U. 2717 is provided to carry out any and all operational aspects of device 2702. Examples of such operations are provided below, with reference to FIG. 28, and may comprise actuating switch 2701 to halt power or other delivery to an appliance, and/or carry out shutdown or other efficiency or performance optimizing routines prior to halting delivery to an appliance, in response to commands, and/or according to programming. For example, in some aspects, device 2702 may halt the delivery of electrical power from an outlet (not pictured) comprising part of a circuit controlled by switch 2701 when certain power consumption and other electrical characteristics activities and states and actuation activities and states are sensed. As another example, when a user actuates switch 2701 by flipping its toggle (now 2703) downward, an external control unit or device, such as unit 2401 and/or 401, may carry out a shut-down routine which may comprise powering down and/or switching off an appliance, for example, via its own main power button, while maintaining power delivery for sufficient time to allow, or until, such a routine is complete—for example, with the aid of an auxiliary power source, such as a battery, resident in such a control unit.

To carry out the former class of operations, halting delivery of electrical power from an outlet, an actuator/motor 2719 may be provided. Actuator/motor 2719 may be powered and controlled by control system 2717, which may be a control system such as those discussed above with reference to FIG. 23. Control system 2717 may itself be powered by, and provide power from, the same circuit comprising switch 2701 with wiring (not pictured) tapping into that same circuit. Actuator/motor 2719 comprises a central axel 2721, powered and rotatable by actuator/motor 2719. Axel 2721 is capable of delivering useful work for switching toggle 2703 on or off (or, if available, actuating toggle 2703 by other degrees or to other positions) via a gear 2723 connected to, and rotatable about a common axis with, axel 2721, and, therefore, powered by actuator/motor 2719. Gear 2723 comprises teeth, such as those examples pictured as 2725, which interface with complementary teeth (such as those examples pictured as 2727) comprised in a rail/gear 2729. Rail 2729 is able to move longitudinally, as it is driven by gear 2723 and, by that token, by actuator/motor 2719, inside a channel 2731 within a housing 2750 of device 2702. Connected with or comprised within rail 2729 is a toggle-holding loop 2733, which surrounds and grips the base of toggle 2703. Toggle-holding loop 2733 preferably comprises sufficient empty space to hold the base of a majority of toggles of a common type of toggle switch, and to permit such a toggle to pivot as it is actuated by the loop 2733 and rail 2729. Because loop 2733 may cover signage on toggle 2703 when it is placed over toggle 2703 during installation of device 2702 onto switch 2701, replacement signage, such as that depicted as I/O indicator 2735, may be present on loop 2733. In other embodiments, however, loop 2733 may comprise a transparent material, allowing viewing of the toggle signage, or may otherwise avoid signage.

Because device 2701 may occupy substantial space distally (out of the page and to the left, in the perspective of the figure) above the mounting plate (now 2705) of the switch 2701, and may block the toggle-framing, coverplate-holding box, 2614, device 2702 may comprise an auxiliary toggle-framing, coverplate-holding box 2714, extending further distally from the covered box 2614. The net effect of that structure is to slightly raise an installed coverplate at the center, making room for components of device 2701, while still permitting such a coverplate to be installed via the plate-fastening screws (now 2711).

It should be understood that, in some embodiments, the functions of device 2702 and light switch 2701 may be integrated into one common unit. In such embodiments, toggle 2703 may be actuable by a motor directly connected to the toggle, rather than via toggle-holding loop 2733. Similarly, any control unit and/or control system set forth in this application, or any parts or aspects thereof, may be resident within, integral with, comprised in or of, or otherwise a part of any other appliance, outlet, circuit switch or other device set forth in this application. Whether or not separate control units and control systems are used, as set forth in this application, to carry out various techniques of the invention, a separate power transmission or communications system or protocol for communicating the various commands and steps of the invention may also be used, which may comprise encryption techniques and techniques for uniquely identifying, authorizing for communication, and communicating with each device required for each such step and communication. Preferably, a universal standard for communicating appliance, control unit and other device actuation commands is used, such that any appliance incorporating or supporting the standard is able to interpret and execute any command or step communicated to it by any other device implementing aspects of the invention with it. As discussed above, the specific examples of wired and wireless communications, power transmission, and other exchanges and techniques between various devices set forth above are exemplary only, and any combination of the techniques set forth in any embodiments may be substituted for any other in any embodiment. For example, control unit 401 set forth in FIG. 4 may comprise a wireless network antenna (such as a near-field communications or Bluetooth antenna) rather than or in addition to hard wiring 413, for communications, commands and power transmission between a peripheral device. To carry the example further, control unit 401 may be comprised within, and part of, outlet 402, which then becomes an outlet/control unit. In such instance, the controls and display aspects may be present on the coverplate of outlet 402, rather than on the housing of unit 401, which would then be omitted, or, as discussed immediately below, omitted altogether in favor of wireless or other control by an external computing device, such as a PDA, networked with the outlet/control unit.

It should generally be understood that, as with control unit 401, and other control units and devices set forth in this application, such a common unit, or device 2702, may be controlled by a commonly-networked smartphone, PDA or other computing device which may be programmed with software, carrying out all or some of the control system and control unit functions discussed in this application. Furthermore, such software may cause such control units and/or devices to execute any of the steps set forth in this application based on any other state(s), condition(s) or activity tracked, or at least aided in tracking, at least in part, by such a smartphone, PDA or other computing device.

FIG. 28 is another process flow diagram depicting additional exemplary steps 2800 that may be executed by a control system, such as the control system discussed with reference to FIG. 23, implementing exemplary programming, methodology and other aspects of the present invention related to devices capable of, among other things, actuating user controls of an appliance.

Beginning with step 2801, the control system first assesses whether power from a power outlet under the control of the control system is presently made available to an appliance under the control of the control system. For example, a power outlet may be under the control of the control system by virtue of a control system being installed onto an outlet, as in FIG. 4, or by virtue of a control system being installed on or within a power switch, as in FIG. 27, controlling an outlet's power. Also by way of example, an appliance may be under the actuation control of a control system by virtue of an appliance-sensing, and -actuating and control unit peripheral device, as in FIGS. 24 and 25. In some embodiments, however, as also mentioned above, the control system may be a part of, and integrated with, the power outlet, the appliance, or other, peripheral devices, and part of the control system may be wirelessly or otherwise networked with other parts (e.g., controlling the outlet and/or appliance by PDA or other networked computer). If outlet power is presently made available to the appliance, the control system proceeds to step 2803, in which it next assesses (with actuation and/or power status indication sensors, or other electrical characteristics and/or power status sensors and techniques as discussed elsewhere in this application) whether the appliance is switched on.

If so, the control system proceeds to step 2805, in which it detects when there is device actuation to cause the appliance or power outlet to switch off. For example, as set forth in step 2807, in some embodiments, an outlet, or a control unit such as unit 401 installed on an outlet, may be actuated to terminate power delivery from the power outlet to an appliance. When an outlet is switched off via a switch, such as the switch set forth in FIG. 26, a control unit may also detect that actuation, in step 2807. As another example, a proxy button on a control unit or control unit peripheral device, as set forth in FIG. 24, may be actuated to switch off an appliance, as also detectable in step 2807. Alternatively, in step 2809, the control system may instead assess that the appliance itself has been actuated to be switched off—for example, by any of the indicator-sensing or appliance actuation-sensing techniques discussed with reference to FIGS. 3, 6-20 and 24.

Following actuation of the power outlet or a control unit installed on, and able to control the provision of power from, a power outlet to switch off power, in step 2807, the control system does not immediately cease the delivery of all power to the appliance powered by the outlet, and controlled by the control system. Instead, the control system delays the termination of power delivery, in step 2811, to continue the provision of power for the duration of any necessary or advisable shutdown, standby and preparation routines required or beneficial to the appliance. Furthermore, the control system may carry out, or take part in carrying out, such routines, as noted, in the subsequent step 2813. For example, a control system connected to and controlling device 2401 of FIG. 24 may issue signals to device 2401 causing it to actuate a main power button of an appliance (on which device 2401 is installed) to instigate such a shut-down routine in the appliance. Furthermore, the control system may monitor and confirm the shutdown status of the appliance prior to ending the provision of power to it, in step 2815, for example, by sensing when a standby/power indicator light indicates such a shutdown status with, for example, a light sensor, such as sensor 2415. Upon confirming that all such necessary or beneficial routines have been carried out, the control system may then terminate power provision from the power outlet (or other source(s) under the control of the control system) to the appliance in step 2817, and return to the starting position. If an outlet is actuated to terminate power to an appliance, in step 2807, an auxiliary power source (such as a local battery) may be used by the control system to continue powering the appliance during shutdown routines. Also, if some shutdown and other required routines undertaken by the appliance as it is switched off can not be monitored, or are difficult to monitor, the control system may, instead or in addition, continue to implement at least some power for at least a duration of time necessary (or probably necessary or tested and proven to be necessary) for such an appliance. For example, although a standby indicator light of an appliance may generally indicate that shutdown routines have been carried out, additional shutdown or other procedures may continue for some time following that indication (for example, saving and/or communicating settings or other use-relevant information following shutdown). In some embodiments, a user or the appliance may communicate information to the control system indicating that the last-implemented delay was insufficient for such routines, and the control system may increase the delay time under such guidance.

Turning our attention back to steps 2805 and 2809, the control system undertakes another series of steps in the event that the appliance itself is being actuated to be switched off. In that case, the control system proceeds, in step 2819, to monitor whether the same types of shutdown or other routines for the appliance discussed immediately above, in reference to steps 2807 et seq., have taken place and have been completed, for example, using the same indication- and actuation-sensing hardware also discussed immediately above, in reference to steps 2807 et seq. Also as mentioned above, the control system may implement an additional delay for carrying out routines that may not be monitored (and tweak such delays, over time) in step 2821. Following that, the control system may then, and only then, end the provision of power to the appliance (for example, from the power outlet) in step 2823, and return to the starting position.

Turning our attention back to step 2801, if the control system determines that power from the power outlet was not then made available to the appliance, it proceeds to step 2825, in which the control system also determines (e.g., with actuation sensors or a proxy or other control of the control system in this instance), whether the appliance is switched on. If so, the control system next proceeds to step 2827, in which it restores power, current, voltage or other electrical characteristics, provided from the outlet and/or control system to the appliance, to meet its needs. In so doing, the control system may also execute, or aid in executing, necessary and/or beneficial start-up routines, before, during, or after restoring such power. For example, the control system may reduce voltage or power shock that would be caused by the binary provision of full power from the outlet by ramping up power delivery gradually, and may test the appliance's load or other operating conditions with the partial provision of such power or other characteristics. As another example, the control system may monitor status indicators, and avoid the provision of full power in the event that a operation failure, error, or other critical event is detected, and the control system may issue alerts to a user and/or other systems in such instances. As another example, and as stated in the following step, 2829, if a proxy button, such as 2417, on a peripheral device of the control system is used to switch on the appliance, the control system may first provide power to the appliance, and, only following that provision, actuate the appliance's power button using, for example, appliance button actuating piece 2541. In this way, the appliance may carry out, or otherwise be in a better state, for receiving power then delivered by the control system. However, a wide variety of additional, other startup routines may also be carried out or facilitated by the control system in accordance with aspects of the present invention, and these examples are illustrative only.

If the appliance is not yet switched on, in step 2825, the control system may proceed to step 2831, in which it monitors any appliance actuation or changes that require, or potentially require, the provision of additional power and/or other electrical characteristics. If and when such increased power needs are sensed and assessed, the control system proceeds, in step 2833, to determine whether immediately available, local power sources (e.g., a local battery or other power source, other than the power outlet) are sufficient to meet such increased needs. If not, the control system may proceed, in step 2835, to obtain additional power to cover such needs, for example, by charging a local battery using the power outlet, ambient, auxiliary or photovoltaic power sources. Alternatively, as also noted in step 2835, the control system may provide such necessary power from, or with the aid of, the power outlet. The control system may then return to the starting position.

Turning our attention back to step 2803, if the control system determines that the appliance is not turned on, and power from the power outlet under is presently made available to an appliance, the control system proceeds to step 2804, in which it ceases providing, or reduces the provision of, such power to the appliance. In addition, the control system may run additional power shut-down routines—including any actions that are necessary, or may benefit the appliance to conduct. For example, as discussed, above, such shutdown routines may include a gradual reduction of provided power, or another pattern of power provision prior to termination, as well as monitoring, repair or communication activities. In addition, following step 2804, the control system may conduct additional maintenance processes and routines, which may be periodic, and may require some, but less than the level of all power from the outlet, in step 2806. In some embodiments, the control system may periodically assess load, current, resistance, or other electrical characteristics of the appliance to determine whether it has been switched on, due to such characteristics previously recorded or associated with the appliance being switched on (or otherwise requiring additional power), and may provide such necessary additional power. In others, informational and communication updates may be necessary from or to the appliance, and the periodic routines may provide sufficient power and other aids to conduct such routines. The control system may also proceed to assess, in step 2808, whether actuation to switch on the appliance, or switch on power to the appliance and/or with the control unit (e.g., actuation of a proxy button or outlet switch, or main power button switch, via sensors) has occurred, and act upon such assessments in subsequent steps, after returning to the starting position.

Generally, the control units set forth in this application may operate to eliminate electronic leakage while retaining the actuation capabilities of an appliance, among other important advantages and aspects of the present invention.

FIG. 29 is an exemplary external GUI 2901, which may be used with an electrical characteristics control unit as set forth in various other embodiments above. As also mentioned above, such a control unit may comprise a control system, such as the control system set forth above in reference to FIG. 23, and may be comprised within or otherwise a part of other devices, such as an outlet or appliance under its control. Exemplary GUI 2901 is comprised in the touch-actuable display of a smartphone or PDA 2903. However, it should be understood that a wide variety of alternative or additional devices may present such a GUI, or another GUI with some of the same control elements. PDA 2903 may be networked, or, at least, intermittently networked, with a control unit, for example, by a local wireless network (such as WiFi, Bluetooth or near-field communications) but also may be networked with, or rely on, other networked devices to carry out all or some of the aspects of the invention set forth in this application. For example, PDA 2903 may be networked with, and utilize hardware and software resident on, a server on the internet, with which PDA 2903 is also connected. Similarly, the control unit may be so networked with a local area network and/or the internet and that server.

GUI 2901 comprises several exemplary touch-actuable control features, such as Main Power control feature 2905 which, when pressed, switches on or switches off power to an appliance, and the appliance itself, through aspects of the invention set forth elsewhere in this application, such as by remotely controlling a control unit (such as 401) commonly networked with the PDA. A Main Power status indicator 2907 is also present in GUI 2901, and relays to the user whether or not the control unit is currently on and/or providing power from the outlet on which it is installed to an appliance, if plugged into the control unit. By lighting up (becoming more illuminated), changing color (e.g., turning red from green), stating the word “ON” rather than “OFF,” or other indication, indicator 2907 is presently indicating that the control unit is switched on and/or providing power to an attached appliance necessary for its ongoing operations. Thus, GUI features 2905 and 2907 perform some of the same tasks as button 414 of FIG. 4 and proxy button 2417, of FIG. 24, and all of the steps and actions set forth in reference to those buttons, elsewhere in this application, may be carried out, instead, using features 2905 and 2907, GUI 2901 and PDA 2903. Similarly, a GUI region 2909 comprises programming features 2911 and 2913 which, similarly to 415 and 417 of FIG. 4, when pressed by a user allow a user to program a control system to recognize the appliance as currently switched on or currently switched off, respectively, and, thus, to recognize subsequent power status actuation (e.g., as monitored by peripheral devices) as actuation to switch off or switch on the appliance, respectively, and the same resulting steps discussed throughout this application related to buttons 415 and 417 (and related to set button 2419) may also occur in relation to features 2911 and 2913. When an appliance controlled by the control system, which, in turn, a user controls through GUI 2901, recognizes that an appliance is presently switched on, feature 2911 may indicate (for example, by lighting up, changing colors or glowing) that that is the case. Conversely, when the control system recognizes that the appliance is presently switched off, feature 2913 may so indicate that that is the case, and may do so with its own unique indication features (e.g., changing to a different color to indicate that the appliance is recognized as switched off than 2911's color when making its indication that the appliance is recognized as on).

Farther down GUI 2901, an expanded region 2915 of features related to advanced settings is provided. An “Advanced” settings indicator 2917 heads this section, and comprises a user actuable arrow 2919 which, when pressed, displays or hides other comprised features in region 2915, discussed below. First, a touch-actuable slider 2921 is present, which allows a user to adjust the sensitivity of the control system to monitored actuation and conditions leading to further system actions. For example, the same sensitivity adjustments carried out by holding down buttons 415 or 417 of FIG. 4 for a sufficient length of time may be carried out by sliding slider 2921 left or right, respectively. Furthermore, slider 2921 displays the current sensitivity setting, and other available degrees of sensitivity via tick marks (such as 2923), with directional indications from plus and minus symbols 2924 and 2925. A conditional action setting feature 2927 is also pictured, and comprises a section heading 2929, followed by a list of current conditional program settings and features 2931. Feature 2933 is at the top of that list, and indicates that the appliance currently subject to GUI 2901 is conditioned to be turned “OFF” upon inactivity indicated by a Passive Infrared Sensor (PIR), which, as with the appliance, may also be present in the kitchen. By digitally actuating feature 2933, a user may deactivate that setting, via subsequently-presented GUI features resulting from that actuation, or adjust, delete or otherwise alter feature 2933. For example, a user may use such subsequent screens to alter the amount of time of sensed inactivity, before switching off a control unit controlling the appliance, or may require additional or a different PIR to confirm inactivity before taking power control actions set forth in this application. In addition to switching off power to an appliance, and/or actuating the main power control of the appliance, as set forth elsewhere in this application with respect to control units carrying out shutdown routines and other aspects of the invention, conditional programming feature 2933 may indicate other control system actions, which may be made conditional on other actions or detected conditions, as may be selected and set by a user. For example, a user may program the control system to turn the appliance and/or control unit power to switch on, rather than off, upon such a condition being met, and multiple conditions may be set, each of which may be required, required by particular threshold degrees, or may be required to occur in a particular order or other pattern, before yielding the conditioned control system, appliance or other device action. In other aspects, the control system may be set to instead issue communications to other devices or appliances, making their actions or other behavior potentially conditional on the those communications, which may themselves be made conditional on control system actions, information (e.g., elapsed timer), or external or networked informational statuses. As one additional listed example, among virtually limitless possibilities, feature 2935 displays a current conditional programming setting that the same control unit or appliance (in the user's Kitchen) will be switched off, and/or power will ceased to be supplied to the appliance, upon the condition that another power supply of a control unit (labeled the “Master”) has itself been turned off. A user of GUI 2901 may view (if present) and add additional conditional programming settings using scroller arrow 2937 and feature addition button 2939, respectively, which, when pressed, may present supplemental GUI features for selecting devices, appliances, their statuses, and other statuses (such as market sell/buy prices for energy, as discussed in the subsequent figure) that may trigger, or be triggered by, actions of the control system set forth in this application.

At the top of the GUI 2901, branding 2941 for the control system, control system administrator, and device manufacture may be included. Also included prominently on GUI 2901 is multiple device selector/indicator 2942, which allows GUI 2901 to display settings, status and control features to control any of several appliances and/or control units controlling those appliances, all of which are commonly networked (or periodically commonly networked) with PDA 2903 or at least some aspects of the control system (e.g., a network server, to which the PDA itself is periodically networked). For example, device title indicator 2943 is pictured as indicating that information, settings and control features for a control unit and/or appliance in a “kitchen” of a user's building, in which a control unit may be installed, is presently being displayed on GUI 2901. To switch to displaying such information, settings and control features for another device controlled by the control system, the user may press drop-carrot 2944, which would then present a list of selectable options, each representing another such device controlled by the control system, for selection (e.g., by pressing such a listed option). Each option, as with title indicator 2942, may then appear in the position of title indicator 2942, and the associated settings and programming features for the titled device or appliance will then be displayed.

In addition to the specific display features set forth immediately above, the GUI 2901 may be generally used by the control system to display any number and type of status indications, actuable features and data, which may be dynamically present, and may include any such displays set forth above with respect to other displays of control systems and control units.

In addition, GUI 2901 may comprise any number of other display elements required or helpful for any function of the control system, such as indicators of the present activities of any aspect of the control system, or networked appliances, or conditional information (e.g., in alert messages presented within the GUI 2901. The specific examples set forth in reference to FIG. 29 are exemplary only, and not exhaustive of the many different display and GUI functions that may be carried out in GUI 2901.

Given the distribution of multiple possible devices, carrying out various aspects of the invention, each such device preferably carries out some, but not all, of those aspects, and each device's physical, energy and other footprint may be minimized in light of the fewer tasks for which it is responsible. For example, in some embodiments, a networked internet server carries out steps for recording, comparing and assessing energy savings optimization data, such as that recorded and compared in steps 2219-2225 of FIG. 22, while the local control unit carries out sensing and/or other, more limited tasks related to the ongoing operation of a power source and appliance (e.g., monitoring operational characteristics to determine if a critical change has occurred.). In one embodiment, the local control unit may retain and implement the latest best record for efficiently supplying the appliance, as set forth in step 2227, comparing it to characteristics observed in the connected appliance, but does not locally store or implement other efficiency metric records, unless so determined by the server or PDA. Or, differences, changes over time, or thresholds between electrical characteristics of an appliance in certain states may be stored and implemented in the control unit, while calculations, determinations and recordings leading to those differences, patterns and thresholds are carried out on the PDA and/or server. Similarly, the timing and order of actuating or executing appliance and control unit controls or aspects may be carried out by the control unit and its peripheral device(s), if any, but the calculations yielding that timing and order may be carried out on the PDA and/or server. As another example, the local control unit, or its peripheral hub or other peripheral device, may carry out monitoring and/or actuation (or wireless signals causing the wireless actuation) of the appliance, via local actuation (and antenna) hardware, while a networked computing device, such as the PDA or server, carries out other recordation and computing tasks.

In other aspects of the invention, additional metric, energy usage display and control aspects are carried out and displayed on an external GUI, which may appear on the same PDA (now 3003) or another device, as pictured in FIG. 30. For example, in GUI 3001, advanced usage and control settings are displayed, which allow a user to determine and observe the amount of energy saved by use of the control system, with respect to each appliance controlled by a control unit(s), as well as the amount of energy consumed by each such appliance. As with the GUI features discussed above, with reference to FIG. 29, such features may be touch-actuable, to reveal additional detail, such as times during the day when each such appliance was “switched on” or otherwise was using more power than other times.

Beginning again with the top of the GUI (now 3001) a user may opt to view the amount of energy savings, by selecting “Savings” among a list of possible Main Display Options, using Main Display Topic Selection feature 3005. Among other options which may be selected for displaying information and other features related to it, by pressing feature 3005, a user may instead select an option showing the amount of energy “Consumed”, as monitored by the control system, or changes in consumption or savings, among many other topic possibilities. The user may also select a relevant timeframe presently subject to GUI 3001, which the displayed information and features will then relate to, using timeframe selection feature 3007. In the figure, the exemplary “Today” timeframe is shown as selected, and, as a result the remaining displayed features and information on GUI 3001 relate to control system, control unit, power supply and/or appliance performance for the latest day. A main figure display 3009 then presents the amount of energy saved due to the operation of certain or any energy-saving aspects of the invention, set forth in this application, which may be calculated by comparing energy consumption figures recorded before implementation of such aspects of the invention, for the appliance while carrying out the same, or related functions. Main figure display 3009 may comprise an energy figure (representing the amount of energy saved in units of energy) 3011 and/or a monetary FIG. 3013 (representing the amount of energy saved in units of monetary cost that would have been incurred at the rates that would have applied to that energy, if it had been expended). Also comprised in main figure display 3009 is a directional (change) indicator 3015, which indicates whether the present period (current day, in the example provided) energy savings represent an improvement or deterioration in energy savings in comparison to the previous such period (an improvement over the previous day, in the example provided, as shown by an upward arrow). In some embodiments, a forced efficiency standard may be imposed, with the use of an energy Adjustment feature 3016. By actuating Adjustment feature 3016, and accessing further specific GUIs with further features for doing so, a user may dictate an energy consumption limit or target for savings for the period, which the control system may enforce by reducing or ending power delivery to appliances according to prioritized rankings of each such appliance, and activities carried out on such appliances. For example, if a limit is in danger of being exceeded, the control system may, in some embodiments, prioritize more recently switched on, or otherwise actuated, appliances, while switching off or reducing power to other appliances. In other embodiments, appliances or control units may be designated as critical by a user, in which case they are given high priority, or are not subject to energy Adjustment by feature 3016. In still other embodiments, such limits and priorities may be flexible and dynamic, their implementation and nature depending upon market conditions, and trends, for energy prices and the ready availability of surplus energy and other credits, as discussed in greater detail, below.

Proceeding farther down GUI 3001, an energy consumption chart feature 3017 may be included, which may display different levels of energy consumption (and/or savings) at particular times within the displayed period. Chart feature 3017 may also permit a user to dictate whether to display consumption for all appliances and devices within the control system, or certain such appliances or devices, using device tracking selection feature 3019. By pressing device selection feature 3019, a user may access a list of possible devices, or sets thereof, about which to display energy consumption and savings information. In the example provided, each vertical bar (such as those examples shown as 3020) of the chart feature bears a numeral (namely, 1, 2, 3, 3, 2, 1, 4, 4, and 4, from left-to-right) indicating the number of appliances and/or outlets or control units presently consuming/providing substantial power.

In some embodiments, an energy market management section 3021 may also be included. Energy market management section 3021 may allow a user to manage the sale of surplus energy or energy-related credits, within the control of the control system, to a larger energy grid. For example, in some embodiments, the control system may locally store (e.g., in a storage cell, or local distribution node controlled by a utility) and/or purchase and sell energy in blocks (energy units exceeding immediate consumption needs) and may do so according to advantageous market conditions. For example, a user may set, using bid selector 3023 and timeframe selector 3025, to sell surplus energy or credits to the highest bidder for such energy units or credits within a given time period (or buy them from a lowest bidder during such a period). In other embodiments, any number of other trading parameters and conditions may also, or alternatively, be set, such as orders, limit orders, derivative product sales and stop losses for re-traded energy units and/or credits, and such conditions may be made dependent on the energy needs, and the elasticity of those needs, depending on priority and “critical” settings, set forth above, of the control system (including all devices or appliances within the control of the control system) within a period, or projected future period. In some embodiments, the amount of energy saved by use of the control system may yield a credit from another entity or agency, such as a governmental environmental agency, and such credits may be traded using such trading features of the invention.

I claim:

1. An apparatus for controlling the distribution of power from a power outlet, comprising:
a control unit, within said power outlet, or installed between said power outlet and said appliance, which further comprises a processing device;
hardware at least partially under the control of at least part of said control unit, configured to control the provision of power from a power outlet to an appliance; and
sensory hardware configured to sense the manual actuation of a power control of an appliance, if said sensory hardware is installed on, in, partially on or in, or near enough to said power control to so sense its manual actuation.

2. The apparatus for controlling the distribution of power from a power outlet of claim 1, further comprising in which, under at least some conditions, said control unit distributes, halts or otherwise controls the provision of power from a power outlet to an appliance, at least in part, based on sensing the manual actuation of a power control of an appliance.

3. The apparatus for controlling the distribution of power from a power outlet of claim 1, further comprising in which, under at least some conditions, said control unit distributes, halts or otherwise controls the delivery of power from a power outlet to an appliance, at least in part, based on the actuated conformation of a power control of an appliance.

4. The apparatus for controlling the distribution of power from a power outlet of claim 1, further comprising in which, under at least some conditions, said control unit distributes, halts or otherwise controls the delivery of power from a power outlet to an appliance, at least in part, based on a determination of a conformation pattern during actuation of a power control of an appliance.

5. The apparatus for controlling the distribution of power from a power outlet of claim 2, further comprising in which said control unit is user-programmable via a user interface.

6. The apparatus for controlling the distribution of power from a power outlet of claim 4, further comprising in which a user may use said user interface and said control unit to record signals, or data representative of or related to said signals, from said sensory hardware, and associate said record(s) with types of manual actuation of said appliance under conditions present during said recording.

7. The apparatus for controlling the distribution of power from a power outlet of claim 2, further comprising in which said control unit determines whether manual actuation to switch off said appliance occurs, and, if so, terminates or modifies the delivery of power from said power outlet to said appliance.

8. The apparatus for controlling the distribution of power from a power outlet of claim 7, further comprising in which said control unit determines whether manual actuation to switch on said appliance occurs, and, if so, provides power, or provides additional power, from said power outlet to said appliance.

9. The apparatus for controlling the distribution of power from a power outlet of claim 8, further comprising in which said sensory hardware is separate from a main housing of said control unit and networked for communications with said control unit.

10. The apparatus for controlling the distribution of power from a power outlet of claim 9, further comprising in which said sensory hardware comprises a fastener which may be installed and uninstalled onto the housing of said appliance, without substantially, permanently changing said appliance, or said sensory hardware comprises an otherwise reversibly adhered device.

11. The apparatus for controlling the distribution of power from a power outlet of claim 2, in which said sensory hardware comprises a near field communications or other communications tag mounted on said power control.

12. The apparatus for controlling the distribution of power from a power outlet of claim 2, in which said sensory hardware comprises a touch-sensitive device.

13. The apparatus for controlling the distribution of power from a power outlet of claim 2, in which said sensory hardware comprises a motion sensor.

14. The apparatus for controlling the distribution of power from a power outlet of claim 11, in which said near field communications or other communications tag, or a part of said sensory hardware of which said near field communications or other communications tag is a part, is user actuable, and communications with said control unit are affected if a user actuates said near field communications or other communications tag or a part of said sensory hardware of which said near field communications or other communications tag is a part.

15. An apparatus for controlling the distribution of power from a power outlet, comprising:
a control unit, which further comprises a processing device;
hardware at least partially under the control of at least part of said control unit, configured to control the provision of power from a power outlet to an appliance; and
sensory hardware configured to sense visual indications of a power status or other appliance condition indicator, if said sensory hardware is installed on, in, partially on or in, or near enough to said indicator to so sense said visual indications.

16. The apparatus for controlling the distribution of power from a power outlet of claim 15, further comprising in which, under at least some conditions, said control unit distributes, halts or otherwise controls the delivery of power from a power outlet to an appliance, at least in part, based on sensing visual indications of a power status indicator of an appliance.

17. The apparatus for controlling the distribution of power from a power outlet of claim 15, further comprising in which said visual indications of a power status indicator comprise a brightness, color or the presence of emitted light from said power status indicator.

18. The apparatus for controlling the distribution of power from a power outlet of claim 15, further comprising in which said visual indications of a power status indicator comprise a pattern or change in brightness, color or the presence of emitted light from said power status indicator.

19. The apparatus for controlling the distribution of power from a power outlet of claim 15, further comprising in which said control unit may be programmed by a user to associate particular types of visual indications with power statuses of an appliance.

20. An apparatus for controlling the distribution of power from a power outlet, comprising:
a control unit within said power outlet, or installed between said power outlet and said appliance, which further comprises a processing device;
hardware at least partially under the control of at least part of said control system, configured to control the provision and use of power; and
sensory hardware configured to sense or otherwise ascertain user activity in the course of actuation, or causing the actuation, of an appliance, which activity affects power usage.
